(19) United States
(12) Patent Application Publication
(10) Pub. No.: US 2011/0148346 A1
(43) Pub. Date: Jun. 23, 2011

(54) Automatic Cycle Storage System, Cycle For Such a System and Docking Structure For Such a Cycle

(75) Inventors: Jean-Claude Gagosz, Bu (FR); Emmanuel Zeferino, Montigny le Bretonneux (FR); Eric Baumann, Feucherolles (FR); Patrick Tavernier, Versailles (FR)

(73) Assignee: JCDecaux SA, Neuilly Sur Seine (FR)

(21) Appl. No.: 12/967,736

(22) Filed: Dec. 14, 2010

(30) Foreign Application Priority Data
Dec. 22, 2009 (FR) 09 59442
May 17, 2010 (EP) 10163037.4

(51) Int. Cl. H02J 7/00; E05B 71/00; H02J 7/04

(52) U.S. Cl. 320/103; 70/233; 320/135; 320/128; 320/137

(57) ABSTRACT

Automatic cycle storage system comprising cycles each comprising a battery, and fixed docking structures to which the cycles can be locked and each comprising an electric power storage device connected to a central processing unit and electrical contacts. The electrical contacts on the cycle and the docking structure connect to each other when the cycle is locked to the docking structure, and the electric power storage device on the cycle then recharges the one on the docking structure.

### SCOPE OF THE INVENTION

The present invention relates to automatic cycle storage systems, cycles for such systems and docking structures for such cycles.

More particularly, the invention relates to an automatic cycle storage system comprising:
a plurality of cycles (for example bicycles) each comprising:
   an electric power storage device,
   electrical contacts,
   an electrical supply circuit connecting the electric power storage device to said electrical contacts,
a plurality of fixed docking structures to which said cycles can be locked, each comprising:
   at least one central processing unit,
   an electrical supply circuit connected to the central processing unit of the docking structure,
   electrical contacts capable of coming into mutual contact with the respective electrical contacts on a cycle locked to the docking structure, connecting the electrical supply circuit of the cycle to the electrical supply circuit of the docking structure.

A cycle storage system as described above can be used for example to make cycles available to the public, subject to identification of the borrower of the cycle, and optionally the payment of a hire fee.

### BACKGROUND OF THE INVENTION

Document EP-A-1 820 722 describes an example of such a cycle storage system.

### OBJECTS OF THE INVENTION

A particular purpose of the present invention is to reduce the consumption by such a system of electricity originating from the public electricity system.

To this end, according to the invention, an automatic cycle storage system of the type in question is characterised in that the electrical supply circuits of the cycle and the docking structure are capable of enabling the electric power storage device on the cycle to supply electricity to the electrical supply circuit of the docking structure when the cycle is locked to the docking structure.

By virtue of these arrangements, the docking structure can be supplied with electricity by the cycle that is locked to this docking structure, and the electricity consumption of the docking structure of electricity originating from the public electricity system is therefore reduced, or even completely eliminated.

In various embodiments of the automatic cycle storage system according to the invention, one or more of the following arrangements may be used (they may be used independently of each other and independently of the aforementioned arrangements):
the electrical supply circuits of the cycle and the docking structure are capable of allowing only the discharging of the electric power storage device from the cycle to the electrical supply circuit of the docking structure, and not the reverse;
the electrical supply circuit of the docking structure is not connected to any external electric power source other than the electric power storage device on the cycle, and the central processing unit on the docking structure communicates with an external control device by means of a wireless link, said external control device communicating with the central unit of the docking structure and being capable of selectively authorising the borrowing of the cycles locked to the docking structures (this avoids having to connect the docking structure to the electricity system. Furthermore, the wireless link connecting the docking structure to the external control device also avoids the use of an underground low current cable. The invention therefore allows for considerably simpler and less costly installation of the docking structure.);
each docking structure comprises an electric power storage device connected to the electrical supply circuit of the docking structure in order to power the central processing unit of the docking structure, the electrical supply circuits of the cycle and the docking structure being capable of enabling the electric power storage device on the cycle to charge the electric power storage device on the docking structure when the cycle is locked to the docking structure;
each cycle also comprises an electric generator capable of charging the electric power storage device on the cycle and of being driven by the moving of said cycle;
said wireless link is a radio link;
the cycle comprises an electronic circuit connected to said electrical contacts on the cycle and said central unit of the docking structure is capable of exchanging information with the electronic circuit on the cycle by means of said electrical contacts on the cycle and the docking structure when they are in mutual contact;
the external control device comprises at least a central server and several central station terminals each corresponding to a cycle storage station, the central station terminals communicating on the one hand with the central server and on the other hand with at least one central processing unit of a docking structure belonging to the same cycle storage station;
each cycle comprises a locking component and each docking structure comprises at least one electric lock controlled by the central processing unit on the docking structure and capable of holding the locking component of one of the cycles, thus locking said cycle to the docking structure, said electric lock being supplied with electricity by the electric power storage device on the docking structure;
each docking structure comprises at least one locking station capable of receiving a cycle and including:
   a keeper open in an engagement direction and capable of receiving the locking component of a cycle by insertion in said engagement direction,
   and said electric lock, comprising a blocking component mobile between on the one hand, a locked position in which said blocking component is capable of blocking the locking component of the cycle in the keeper and on the other hand, an unlocked position in which the blocking component is capable of allowing the locking component to enter and exit the keeper;
the electrical contacts on the cycle and the docking structure are in mutual contact in a bearing direction substantially perpendicular to the engagement direction when the cycle is locked to the docking structure;
the electrical contacts on the cycle and the docking structure are in mutual contact in said engagement direction when the cycle is locked to the docking structure;
the engagement direction is substantially vertical, with the keeper being open upwards;
the cycle locking component comprises a transverse bar extending along a longitudinal axis between two ends, the keeper comprising at least one receiving trough open in said engagement direction and capable of receiving said transverse bar with its longitudinal axis arranged substantially along a fixed horizontal axis defined by the receiving trough, and the lock comprises at least one actuating component that is connected to the blocking component, said actuating component being mobile with the blocking component in a vertical plane perpendicular to said fixed horizontal plane, between:
   a first position corresponding to the unlocked position of the lock, in which said actuating component is arranged in order to interfere with the transverse bar of the locking component when said transverse bar is engaged in the receiving trough in the engagement direction,
   and a second position corresponding to the locked position of the lock, said transverse bar of the locking component being capable of moving the actuating component from its first to its second position when said transverse bar is inserted into the receiving trough, and said actuating component being capable of actuating the lock when it passes from its first to its second position by moving the blocking component to the locked position;
the blocking component and the actuating component belong to a single lock part that is mounted pivotably between the locked and unlocked positions, around a horizontal axis of rotation substantially parallel to said fixed horizontal axis defined by the receiving trough;
the lock part is elastically forced towards the unlocked position and the electric lock comprises a tumbler that is mobile between on the one hand, an abutment position in which said tumbler is capable of holding the lock part in the locked position and on the other hand, a retracted position in which said tumbler enables the lock part to move to the locked position, the tumbler being elastically forced towards the abutment position and the electric lock also comprising an electric actuator capable of moving the tumbler from its abutment position to its retracted position;
the lock part comprises a lock plate that extends substantially perpendicular to the fixed horizontal axis and which comprises a notch capable of receiving the transverse bar, said lock plate forming two lips that frame said notch and respectively constitute the blocking component and the actuating component;
the locking component of the cycle comprises a connecting part integral with the transverse bar and forming a T with said transverse bar, and the lock part comprises two lock plates attached to each other and capable of engaging on the transverse bar on either side of the connecting part;
the receiving trough and the notch in the lock plate are capable of allowing the rotation of the transverse bar about its longitudinal axis;
the keeper comprises two receiving troughs arranged to each receive one end of the transverse bar;
the keeper also comprises lateral walls each cooperating by abutment with one end of the transverse bar in order to centre said transverse bar when the cycle is locked to the locking station;
the cycle comprises handlebars integral with forks that bear the front wheel, the locking component of the cycle being integral with the forks of the cycle;
the docking structure forms a stand comprising a slot capable of receiving the front wheel of the cycle when it is locked to said docking structure;
the docking structure comprises a substantially horizontal beam comprising several locking stations;
the docking structure comprises at least one electric power storage device and the electrical supply circuits of the cycle and the docking structure are capable of enabling the recharging of the electric power storage device on the docking structure by the electric power storage device on the cycle as long as the electric power storage device on the cycle has a charge greater than a non-zero minimum charge level;
the docking structure is connected to at least one electric power source and comprises at least one electric power storage device, the electrical supply circuit of the docking structure being capable of enabling the recharging of the electric power storage device on the docking structure by said electric power source when the electric power storage device on the docking structure reaches a low charge threshold.

Furthermore, an additional object of the invention is a docking structure for an automatic cycle storage system as defined above, capable of locking a cycle that comprises an electric power storage device, electrical contacts and an electrical supply circuit connecting the electric power storage device to said electrical contacts, said docking structure comprising:
at least one central processing unit capable of selectively authorising the borrowing of a cycle locked to the docking structure,
an electrical supply circuit connected to the central processing unit of the docking structure,
electrical contacts capable of coming into mutual contact with the respective electrical contacts on a cycle locked to the docking structure, connecting the electrical supply circuit of the cycle to the electrical supply circuit of the docking structure,
   characterised in that the electrical supply circuit of the docking structure is capable of being supplied with electricity by the electric power storage device on the cycle when the cycle is locked to the docking structure.

In various embodiments of the docking structure according to the invention, one or more of the following arrangements may be used (they may be used independently of each other and independently of the aforementioned arrangements):
the electrical supply circuit on the docking structure is capable of allowing only the discharging of the electric power storage device from the cycle to the electrical supply circuit of the docking structure, and not the reverse;
said supply circuit of the docking structure is not connected to any external electric power source other than the electric power storage device on the cycle, and the central processing unit on the docking structure is connected to a communications interface capable of communicating with an external control device via a wireless link;
the docking structure comprises an electric power storage device connected to the electrical supply circuit of the docking structure to power the central processing unit of the docking structure, the electrical supply circuit of the docking structure being capable of enabling the electric power storage device on the docking structure to be charged by the electric power storage device on the cycle when the cycle is locked to the docking structure;
said wireless link is a radio link;
said central processing unit on the docking structure is capable of exchanging information with an electronic circuit of a cycle locked to the docking structure by means of said electrical contacts on the docking structure;
the docking structure comprises at least one electric lock controlled by the central processing unit on the docking structure and capable of holding a locking component of a cycle, thus locking said cycle to the docking structure;
the docking structure comprises at least one locking station capable of receiving a cycle and including:
a keeper open in an engagement direction and capable of receiving the locking component of a cycle by insertion in said engagement direction,
and said electric lock, comprising a blocking component mobile between on the one hand, a locked position in which said blocking component is capable of blocking the locking component of the cycle in the keeper and on the other hand, an unlocked position in which the blocking component is capable of allowing the locking component to enter and exit the keeper;
the keeper comprises at least one receiving trough open in the engagement direction and capable of receiving a transverse bar belonging to the locking component of the cycle with its longitudinal axis arranged substantially along a fixed horizontal axis defined by the receiving trough, and the lock comprises at least one actuating component that is connected to the blocking component, said actuating component being mobile with the blocking component in a vertical plane perpendicular to said fixed horizontal axis, between:
   a first position corresponding to the unlocked position of the lock, in which said actuating component is arranged to interfere with the transverse bar of the locking component when said transverse bar is engaged in the receiving trough in the engagement direction,
   and a second position corresponding to the locked position of the lock, said transverse bar of the locking component being capable of moving the actuating component from its first to its second position when said transverse bar is inserted into the receiving trough, and said actuating component being capable of actuating the lock when it passes from its first to its second position by moving the blocking component to the locked position;
the blocking component and the actuating component belong to a single lock part that is mounted pivotably between the locked and unlocked positions, around a horizontal axis of rotation substantially parallel to said fixed horizontal axis defined by the receiving trough;
the lock part is elastically forced towards the unlocked position and the electric lock comprises a tumbler that is mobile between on the one hand, an abutment position in which said tumbler is capable of holding the lock part in the locked position and on the other hand, a retracted position in which said tumbler enables the lock part to move to the locked position, the tumbler being elastically forced towards the abutment position and the electric lock also comprising an electric actuator capable of moving the tumbler from its abutment position to its retracted position;
the lock part comprises a lock plate that extends substantially perpendicular to the fixed horizontal axis and comprises a notch capable of receiving the transverse bar, said lock plate forming two lips that frame said notch and respectively constitute the blocking component and the actuating component;
the lock part comprises two lock plates integral with each other and capable of engaging on the transverse bar on either side of a connecting part forming a T with said transverse bar;
the receiving trough and the notch in the lock plate are arranged to form a circular inner contour centred on the fixed horizontal axis;
the keeper comprises two receiving troughs arranged to each receive one end of the connecting bar;
the keeper also comprises lateral walls each capable of cooperating by abutment with one end of the transverse bar in order to centre said transverse bar when the cycle is locked to the locking station;
the docking structure forms a stand comprising a slot capable of receiving the front wheel of the cycle when it is locked to said docking structure;
the docking structure comprises a substantially horizontal beam comprising several locking stations.

A further object of the invention is a cycle for an automatic cycle storage system as defined above, capable of being locked to a docking structure that comprises at least one central processing unit, an electrical supply circuit connected to the central processing unit on the docking structure and electrical contacts, said cycle comprising:
an electric power storage device,
electrical contacts capable of coming into contact with the electrical contacts on the docking structure when the cycle is locked to said docking structure,
an electrical supply circuit connecting the electric power storage device on the cycle to said electrical contacts on the cycle,
   the electrical supply circuit of the cycle being capable of enabling the electric power storage device on the cycle to supply power to the electrical supply circuit of the docking structure when the cycle is locked to the docking structure.

In various embodiments of the cycle according to the invention, one or more of the following arrangements may be used (they may be used independently of each other and independently of the aforementioned arrangements):
the electrical supply circuit of the cycle is capable of enabling only the discharging of the electric power storage device on the cycle to the electrical supply circuit of the docking structure, and not the reverse;
the cycle also comprises an electric generator capable of charging the electric power storage device on the cycle and of being driven by the moving of said cycle;
the cycle comprises an electronic circuit connected to said electrical contacts on the cycle and capable of exchanging information with said central unit on the docking structure by means of said electrical contacts on the cycle;
the electrical contacts on the cycle are oriented vertically downwards;
the cycle comprises a locking component comprising a transverse bar extending substantially horizontally in a normal position of use of the cycle;
the locking component of the cycle comprises a connecting part integral with the transverse bar and forming a T with this transverse bar;
the cycle comprises handlebars integral with forks that bear the front wheel, the locking component of the cycle being integral with the forks of the cycle;
the locking component comprises a connecting part connecting the transverse bar to a bracket integral with the forks, this connecting part extending substantially horizontally in the normal position of use of the cycle, and said connecting part being connected to the bracket by a flexible connector capable of enabling the vertical travel of said connecting part.

A further object of the invention is an automatic cycle storage system comprising:
a plurality of cycles (for example bicycles) each comprising a locking component,
a plurality of fixed docking structures to which said cycles can be locked, each comprising at least one locking station capable of receiving a cycle and including:
   a keeper open upwards in a substantially vertical engagement direction and capable of receiving the locking component of a cycle by insertion in said engagement direction,
   and an electric lock, comprising a blocking component mobile between on the one hand, a locked position in which said blocking component is capable of blocking the locking component of the cycle in the keeper and on the other hand, an unlocked position in which the blocking component is capable of allowing the locking component to enter and exit the keeper,
      the locking component on the cycle comprising a transverse bar extending along a longitudinal axis between two ends, the keeper comprises at least one receiving trough open upwards and capable of receiving said transverse bar with its longitudinal axis arranged substantially along a fixed horizontal axis defined by the receiving trough,
      the transverse bar, the receiving trough and the electric lock being formed so that the transverse bar can rotate about its longitudinal axis when the cycle is locked to the docking structure.

A further object of the invention is a cycle comprising a locking component including a transverse bar extending substantially horizontally in a normal position of use of the cycle, the cycle comprising handlebars integral with forks that bear the front wheel, the locking component comprising a connecting part connecting the transverse bar to a bracket integral with the forks, such connecting part extending substantially horizontally, in the normal position of use of the cycle, and said connecting part being connected to the bracket by a flexible connector to enable the vertical travel of said connecting part.

In various embodiments of this latter automatic cycle storage system according to the invention, one or more of the following arrangements may be used (they may be used independently of each other or combined with each other or combined with all of the various aforementioned arrangements):
the lock comprises at least one actuating component that is connected to the blocking component, said actuating component being mobile with the blocking component in a vertical plane perpendicular to said fixed horizontal axis, between:
   a first position corresponding to the unlocked position of the lock, in which said actuating component is arranged to interfere with the transverse bar of the locking component when said transverse bar is engaged in the receiving trough in the engagement direction,
   and a second position corresponding to the locked position of the lock, said transverse bar on the locking component being capable of moving the actuating component from its first to its second position when said transverse bar is inserted into the receiving trough, and said actuating component being capable of actuating the lock when it passes from its first to its second position by moving the blocking component to the locked position.
the blocking component and the actuating component belong to a single lock part that is mounted pivotably between the locked and unlocked positions, around a horizontal axis of rotation substantially parallel to said fixed horizontal axis defined by the receiving trough;
the lock part is elastically forced towards the unlocked position and the electric lock comprises a tumbler that is mobile between on the one hand, an abutment position in which said tumbler is capable of holding the lock part in the locked position and on the other hand, a retracted position in which said tumbler enables the lock part to move to the locked position, the tumbler being elastically forced towards the abutment position and the electric lock also comprising an electric actuator capable of moving the tumbler from its abutment position to its retracted position;
the lock part comprises a lock plate that extends substantially perpendicular to the fixed horizontal axis and comprises a notch capable of receiving the transverse bar, said lock plate forming two lips that frame said notch and respectively constitute the blocking component and the actuating component;
the locking component of the cycle comprises a connecting part integral with the transverse bar and forming a T with said transverse bar, and the lock part comprises two lock plates attached to each other and capable of engaging on the transverse bar on either side of the connecting part;
the keeper comprises two receiving troughs arranged to each receive one end of the connecting bar;
the keeper also comprises lateral walls each cooperating by abutment with one end of the transverse bar in order to centre said transverse bar when the cycle is locked to the locking station;
the transverse bar has a substantially circular cross-section;
the docking structure forms a stand comprising a slot capable of receiving the front wheel of the cycle when it is locked to said docking structure;
the cycle comprises handlebars integral with forks that bear the front wheel, the locking component of the cycle being integral with the forks of the cycle;
the docking structure comprises a substantially horizontal beam comprising several locking stations.

### BRIEF DESCRIPTION OF THE DRAWINGS

Further characteristics and advantages of the invention will become apparent on reading the following description of several of its embodiments, given as non-limitative examples, in relation to the attached drawings.

On the drawings:

FIG. 1 is a perspective diagrammatic view showing an automatic cycle storage system according to a first embodiment of the invention,

FIG. 2 is a detailed view showing the locking of a cycle to one of the stands forming the cycle docking structures in FIG. 1,

FIG. 3 is a detailed view showing the locking component held by the cycle in FIG. 2,

FIG. 4 is a side view of the stand to which the cycle in FIG. 2 is locked,

FIG. 5 is a simplified exploded view of the keeper on the stand in FIG. 4,

FIG. 6 is a block diagram showing the operation of the keeper in FIG. 5, shown in the form of a cross-section along the line VI-VI in FIG. 5,

FIG. 7 is a block diagram showing the main electrical components of the cycle storage system in FIGS. 1 to 6,

FIG. 8 is a perspective diagrammatic view showing an automatic cycle storage system according to a second embodiment of the invention,

FIG. 9 is a perspective view of one of the cycles in the system in FIG. 8,

FIG. 10 is a detailed three-quarters bottom view of the locking component of the cycle in FIG. 9,

FIG. 11 is a cross-sectional view of part of the locking component in FIG. 10, showing electrical contacts provided in this locking component,

FIG. 12 is a side view of the cycle in FIG. 9 locked to one of the stands forming the cycle docking structures of the system in FIG. 8,

FIG. 13 is a detailed perspective view of the stand in FIG. 12 in the locked position, the cycle being omitted for greater clarity,

FIG. 14 is a vertical cross-sectional view of the keeper on the stand in FIG. 13, at the level of a lateral receiving trough comprising electrical contacts,

FIG. 15 is a three-quarters rear perspective view of the keeper on the locking stand in FIG. 13, in the locked position,

FIGS. 16 and 17 are perspective views in two different directions showing the electric lock fitted to the keeper on the locking stand in FIG. 13, in the locked position,

FIG. 18 is a vertical cross-sectional view of the electric lock in FIGS. 16 and 17, along the median plane of this electric lock,

FIG. 19 is a block diagram of the automatic cycle storage system according to the second embodiment of the invention,

FIG. 20 is a vertical cross-sectional view, in the same median plane as FIG. 18, showing the keeper on the locking stand in FIG. 13 with its electric lock in the unlocked position,

FIG. 21 is a similar view to FIG. 19, showing the keeper in perspective and in vertical cross-section,

FIG. 22 is a perspective view showing an automatic cycle storage system according to a third embodiment of the invention,

FIGS. 23 and 24 are similar views to FIGS. 10 and 13 respectively, in a fourth embodiment of the invention,

FIG. 25 is a perspective view showing a cycle locked to a docking structure, in a fifth embodiment of the invention,

FIGS. 26 and 27 are partial vertical cross-sectional views showing the locking of the cycle in FIG. 25 to its docking structure, and showing the electric lock on the docking structure in the unlocked position and the locked position respectively,

FIGS. 28 and 29 are perspective views showing two variants of the fifth embodiment of the invention,

FIG. 30 is a detailed perspective view showing the attachment component of a cycle in the fifth embodiment of the invention,

FIG. 31 is a vertical cross-sectional view of the attachment component in FIG. 30,

FIGS. 32 and 33 are similar views to FIGS. 1 and 7 respectively, in a sixth embodiment of the invention,

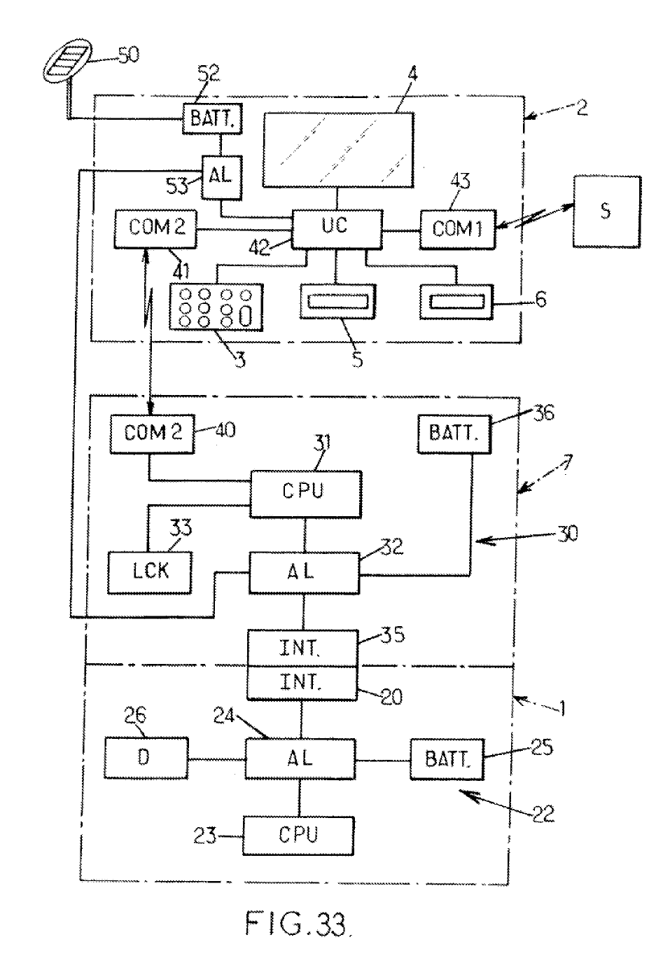

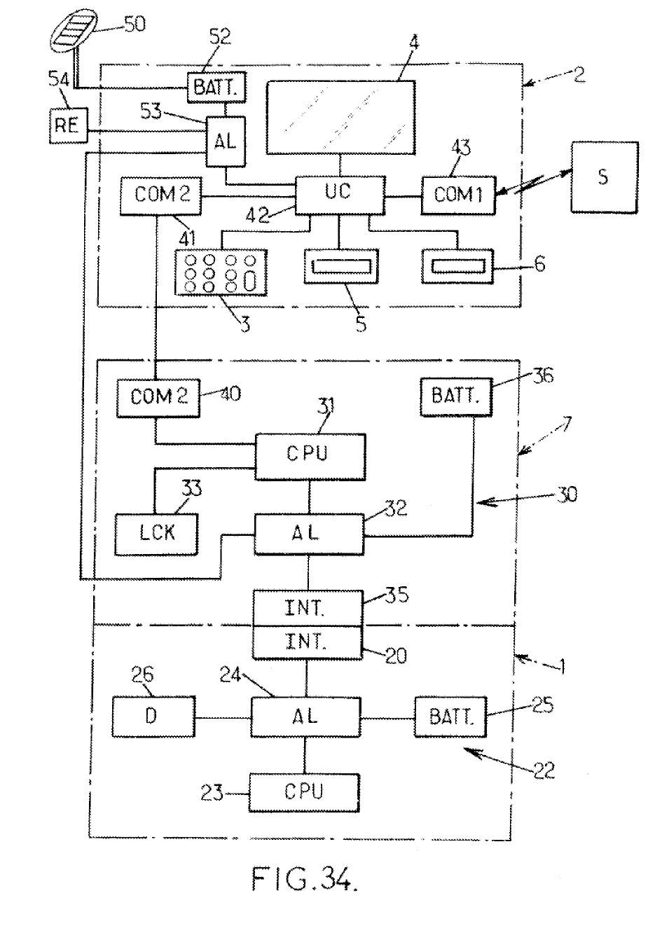

and FIG. 34 is a block diagram similar to FIG. 33, showing a variant of the sixth embodiment of the invention.

### MORE DETAILED DESCRIPTION

In the various figures, the same reference denotes identical or similar components.

### First Embodiment

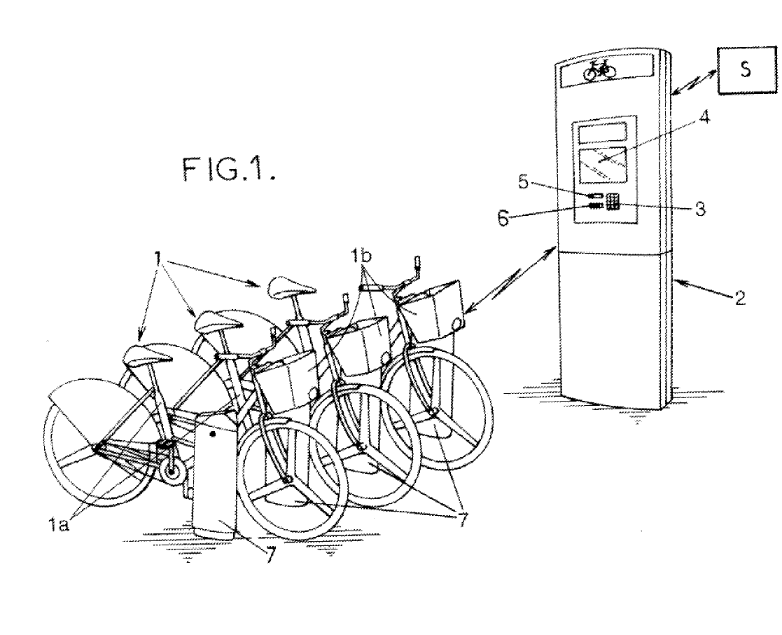

As shown in FIG. 1, the present invention relates to an automatic cycle storage system 1 for cycles such as in particular bicycles, allowing for example for cycles to be stored on a public thoroughfare so that they can be made available to the public.

This automatic cycle storage system can comprise several cycle storage stations, one of which is shown in FIG. 1. Each cycle storage station comprises a central station terminal 2, which is shown here in the form of an interactive terminal equipped with a user interface comprising for example a keypad 3, a screen 4, a portable electronic card reader 5, a ticket printing device 6, etc. As a variant, the interactive terminal 2 could not comprise a user interface and be a simple communications gateway between the cycle storage station and a central server S.

The interactive terminal 2 communicates on the one hand with the central server S, which manages subscriptions and cycle hire, and on the other hand with a plurality of docking structures 7 that allow for the cycles to be locked during their storage and which can for example take the form of locking stands fixed to the ground on a public thoroughfare. Here, each locking stand is capable of enabling the locking of a single cycle 1, and thus constitutes a single cycle locking station.

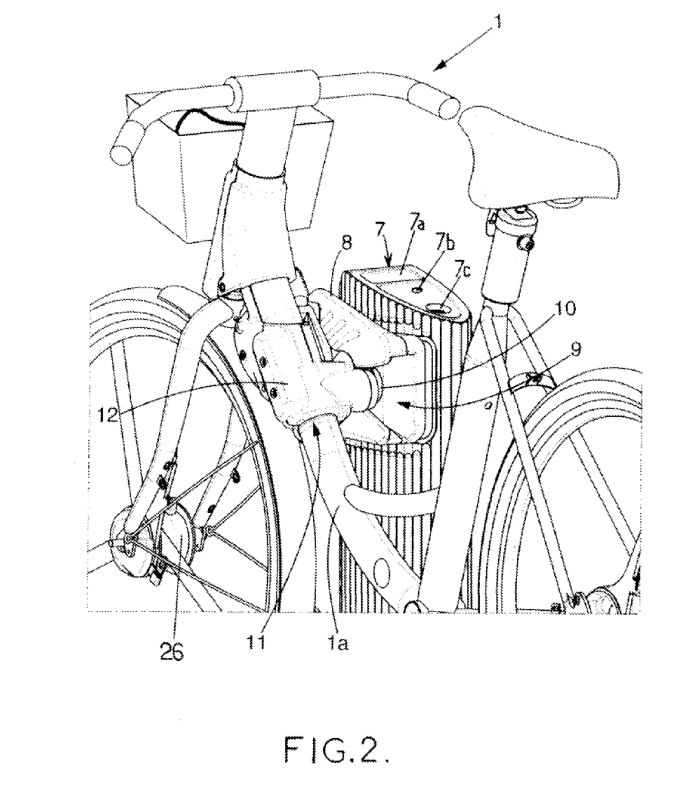

As can be seen in FIG. 2, each docking structure 7 comprises a keeper 8 forming a rigid housing equipped with a notched opening 9 open horizontally and capable of receiving and holding a locking component 10 belonging to a locking device 11 integral for example with the frame 1a of one of the cycles 1.

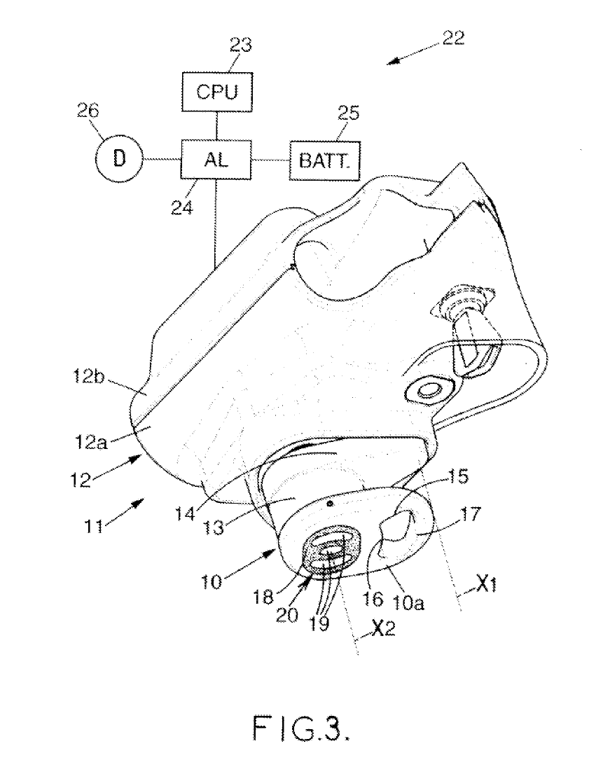

As can be seen in FIG. 3, the locking device 11 can comprise a bracket 12, which can for example be made in two parts 12a, 12b, attached to each other and encircling one of the tubes of the frame 1a of the cycle. The locking component 10 may be mounted movably on the bracket 12 in order to enable a certain travel of the locking component 10 at least vertically relative to said cycle, as explained in document EP-A-1 820 721.

More particularly, the locking component 10 can be mounted pivotably relative to the bracket 12, around a horizontal rotation axis X1 perpendicular to the mid-plane of the locking component 10. In the example shown in the drawings, the locking component 10 comprises a vertical metal plate 10a that is integral with a cylindrical hub 13 rotating about a central axis X2 parallel to the axis X1 and offset relative to X1, the hub 13 itself being integral with a lever arm 14 that is mounted pivotably on the bracket 12 around the axis of rotation X1.

The locking component 10 extends forwards, that is, towards the axis of rotation X1, from the hub 13. At its front end, said locking component 10 comprises a through-hole 15 that is open parallel to the axes X1, X2, and that has radially inner and radially outer arc-shaped edges 16, 17, substantially centred on the central axis X2. Furthermore, in line with the hub 13, the plate 10a of the locking component 10 comprises an electrically insulating zone 18, facing away from the housing 12, in which are arranged metal electrical contacts 19 forming an electrical interface 20. These electrical contacts can for example be three in number and comprise for example:
a flat central contact arranged in line with the central axis X2, this central contact preferably being elongated substantially horizontally,
and two generally curved contacts, elongated substantially horizontally, which are arranged on either side of the central contact, these generally curved contacts being flat and each having a curved contour, with a concavity facing towards the central axis X2.

It will be noted that the locking component 10 could comprise a number of electrical contacts 19 other than three (for example two contacts).

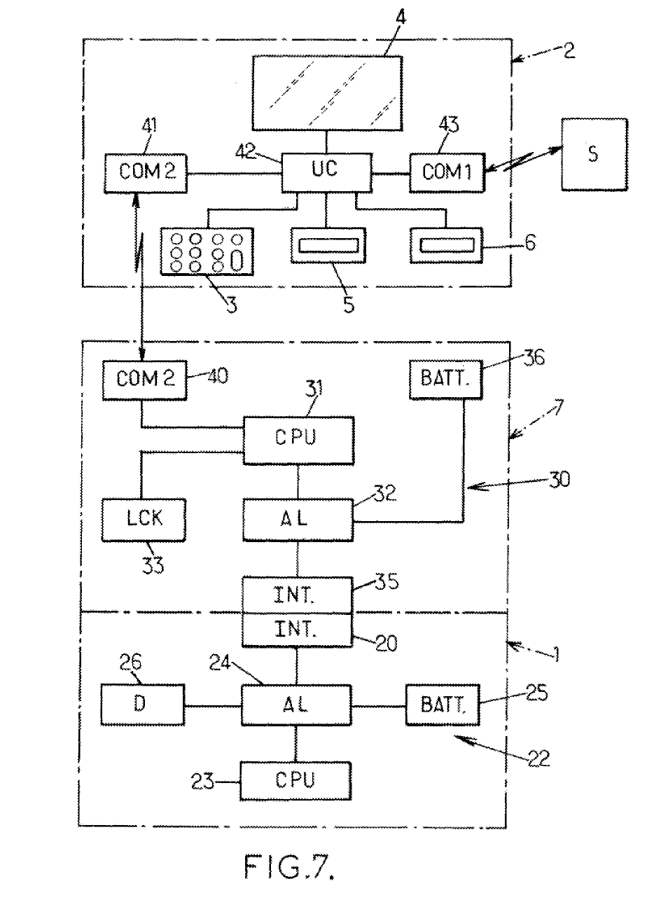

The electrical contacts 19 allow, when the cycle 1 is locked to a docking structure 7, for said docking structure to be electrically connected to an electrical circuit 22 belonging to the cycle 1, shown in FIG. 7.

This electrical circuit 22 can comprise for example at least:
a central processing unit 23 (CPU) such as a microprocessor or a microcontroller, capable of communicating with the docking structure 7,
a low voltage electrical supply circuit 24 (AL) operating for example at 6V or 3V, which supplies power to the central processing unit 23,
a low voltage battery 25 (BATT.) connected to the electrical supply circuit 24,
and an electric generator such as a dynamo, for example a hub dynamo 26 (D) that can be housed for example in the hub of the cycle (see FIG. 2) to generate electric current when the cycle is ridden, this electric generator also being connected to the electrical supply circuit to charge the battery 25.

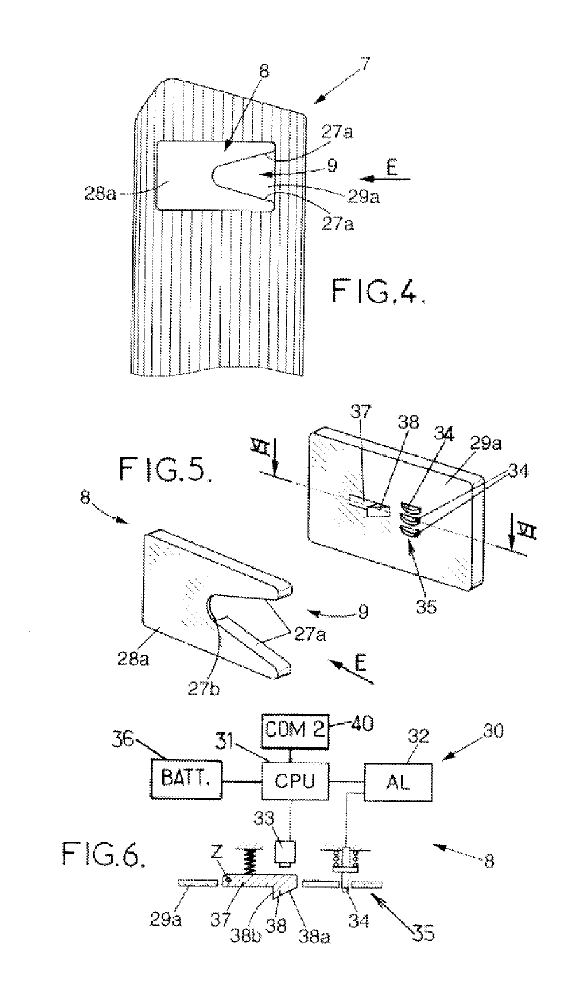

As shown in FIGS. 4 and 5, the notched opening 9 on the keeper 8 advantageously comprises two guides 27a in the form of ramps converging with each other in the horizontal engagement direction E of the locking component 10 in the keeper 8. These guides 27a are to be adjusted to cooperate with the plate 10a of the locking component to move the locking component 10 about the axis of rotation X1 to a nominal locked position relative to the keeper 8. It is thus ensured that the locking component 10, and more particularly the hole 15 in such locking component, is at the right height relative to the keeper 8 after insertion into said keeper, in the engagement direction E.

As can be seen in FIG. 5, the keeper 8 comprises a housing 28a, including for example the notched opening 9 and the guides 27a, and a base 29a.

As can be seen in FIGS. 6 and 7, the base 29a can comprise an electrical circuit 30 comprising for example:
a central processing unit 31 (CPU) such as a microprocessor or microcontroller,
a low voltage electrical supply circuit 32 (AL) (operating at the same voltage as the electrical supply circuit 24 of the cycle, for example at 3V or 6V) supplying power to the central unit 31,
a lock control electromagnet 33 (LCK) supplied with power by the electrical supply circuit 32 and controlled by the central unit 31,
electrical contacts 34, for example three in number, connected to the electrical supply circuit 32 and forming an electrical interface 35,
a battery 36 (BATT.) supplying low voltage power to the circuit 32,
a wireless communications interface 40 (COM 2) connected to the central unit 31 and allowing for communication with the interactive terminal 2 using a short-range radio protocol such as the BLUETOOTH, ZIGBEE, or other protocols,
optionally, various accessories connected to the central unit 31, for example a contactless card reader 7a, an indicator 7b and a control button 7c arranged for example on the upper face of the stand 7 (see FIG. 2), being able to be used for example to trigger the unlocking of a cycle 1 locked to the stand 7 once unlocking authorisation has been acquired.

The electrical contacts 34 can in particular take the form of pins protruding from the base 29 and capable of coming into contact respectively with the electrical contacts 19 on the locking component when the cycle is locked to the locking stand 7. The electrical contacts 34 can for example be substantially vertically aligned with each other; they are electrically insulated from each other for example by the housing of the base 29a, which can be made from an electrically insulating material.

Furthermore, the base 29 also comprises an attachment component 37 such as for example a hook mounted pivotably around a vertical axis Z and equipped with a lip 38 protruding relative to the base 29a. The hook 37 is elastically forced towards an idle position in which the lip 38 protrudes relative to the base 29, so that when the locking component 10 is engaged in the keeper 8 in the engagement direction E, the lip 38 is pushed back into a retracted position by cooperation between a sloped surface 38a of the lip 38 and the front edge of the plate 10a, then said lip 38 is engaged in the hole 15 in the plate 10a, then holding said plate by cooperation between a stopping edge 38b belonging to the lip and the outside edge 17 of the hole 15.

In this position, the hub 13 of the locking component is preferably in contact with the end edge 27b of the notched opening 9 in the cover 28a, so that the cycle 1 is then locked to the locking stand 7 with little play. The relative positions of the lip 38 and the contacts 34-36 relative to the locking component 10 are shown in chain dotted lines in FIG. 7, in the locked position of the cycle 1 to the locking stand 7.

The attachment component 37 can also be moved to a retracted position by the electromagnet 33, to allow for the cycle 1 to be removed from the locking stand 7.

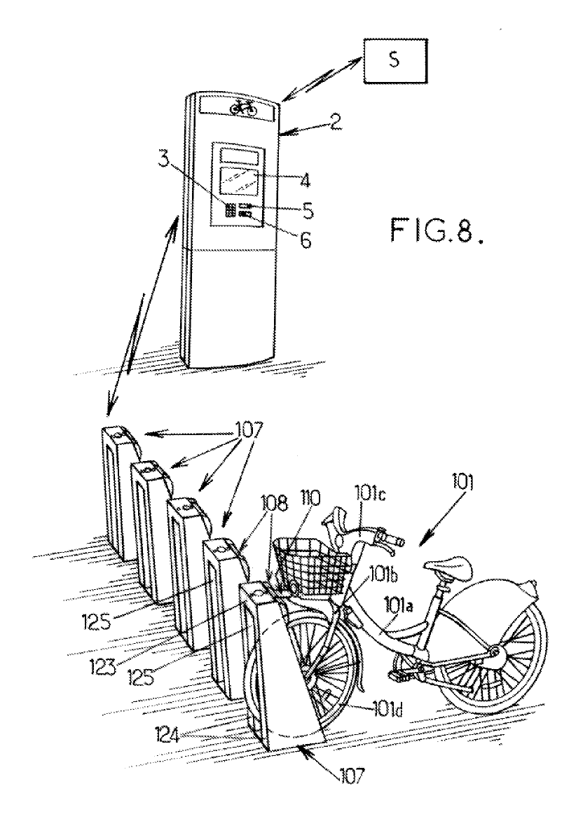

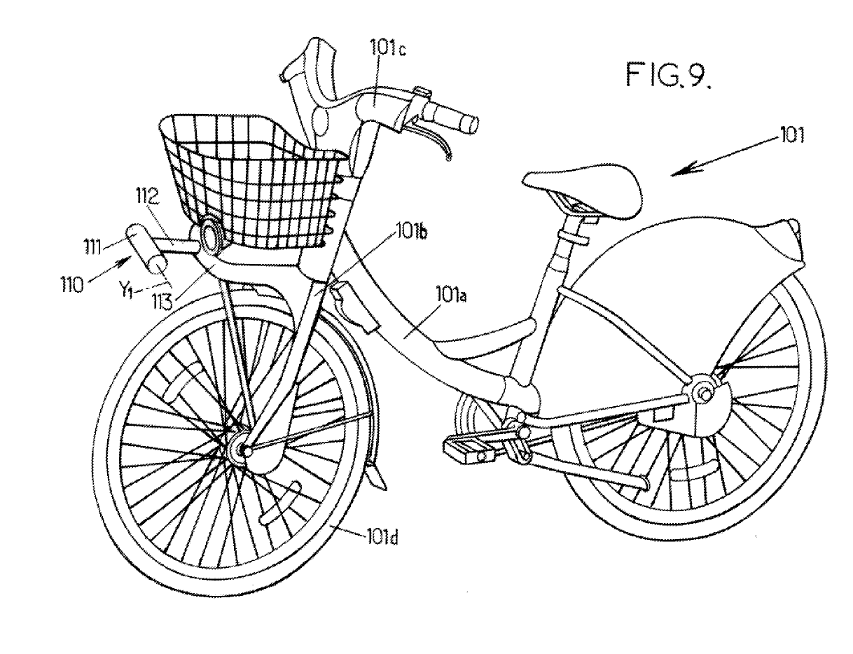

As shown in FIGS. 8 and 9, the locking component 10 is elastically forced towards an idle position by a spring 39.

Each locking stand 7 is independent and is not therefore connected to the outside by any electric power cable or by any low current data transmission cable, which greatly facilitates the installation of the stands 7.

For its part, the interactive terminal 2 can comprise a central processing unit 42 (UC) such as a microprocessor or other, which communicates with:
the aforementioned keyboard 3, screen 4, card reader 5 and printing device 6,
a wireless communications interface 42 (COM 1), itself communicating with the communications interface 40 on each stand 7 and operating on the same communications protocol thereof,
a communications interface 43 (COM 1), for example a GPRS modem or other, capable of communicating with the central server S.

The system described above operates as follows.

When a user wishes to borrow a cycle 1 from one of the locking stands 7, he can for example insert a portable electronic card in the reader 5 on the interactive terminal 2 and then enter a secret code using the keypad 3, in order to identify himself to said interactive terminal. Having checked the user's rights with the server S, the interactive terminal 2 gives an unlocking authorisation to one of the locking stands 7 so that a user can unlock the cycle 1 located on the stand by pressing the aforementioned button 7c. The user can then take the cycle 1, and the central processing unit 31 on the locking stand then notes the removal of the cycle 1 as it can no longer communicate with central processing unit 23 on the cycle. The central processing unit 31 on the locking stand 7 then informs the interactive terminal 2 of such removal.

When the user returns the cycle 1 and places it on a locking stand 7, he engages the locking component 10 in the keeper 8 on the locking stand. During this movement, the locking component 10 pivots about the pivoting axis X1, guided by the guides 217a on the keeper 8, so that the hole 15 in said locking component lines up perfectly with the lip 38 of the attachment component and so that the electrical contacts 19 on the cycle line up perfectly with the electrical contacts 34 on the keeper. The central processing unit 31 on the locking stand can then communicate with the central processing unit 23 on the cycle by means of at least some of the contacts 19 and 34 in order to identify the cycle and inform the interactive terminal 2 that the cycle has been returned.

In addition, the electrical supply circuit 22 of the cycle 1 then supplies power to the supply circuit 30 of the locking stand 7 by means of at least some of the contacts 19, 34, and the two circuits are designed so that the battery 25 of the cycle, previously charged by the dynamo 26 on the cycle, can thus recharge the batter 36 of the stand 7. The electrical supply circuits 24, 32 of the cycle and the docking structure are capable of enabling the recharging of the battery 36 of the docking structure by the battery 25 of the cycle as long as the electric power storage device of the cycle has a charge greater than a non-zero minimum charge level, for example at least 10% of its nominal charge (in other words, fully discharging the battery 25 of the cycle by recharging the battery 36 is avoided).

It will be noted that it is possible to either:
use different contacts 19, 34 for on the one hand, exchanging information between the central units 24, 31 on the cycle and the stand and on the other hand, recharging the battery 36 of the stand,
or use the same contacts 19, 34 for these two functions, the information exchange signals between the central units then being for example separated by filtering.

It will be noted that as a variant, the transmission of data between the central units 23, 31 could take place by wireless link (for example a very short range radio link, in particular an RFID link) in all of the embodiments of the invention, with only the power supply to the cycle docking structure then passing through the electrical contacts on the cycle and the docking structure.

According to another variant, the battery 25 of the cycle and/or the battery 36 of the docking structure could be replaced by any other electric power storage device, for example super

capacitors or others. In addition, the battery 36 or other electric power storage device of the docking structure could optionally be eliminated, in which case the docking structure 7 would be supplied with electric power by the battery 25 or other power storage device on the cycle, only when the cycle is locked to the docking structure 7.

All of the abovementioned variants can be used not only in the first embodiment described above, but also in all of the other embodiments described below.

### Second Embodiment

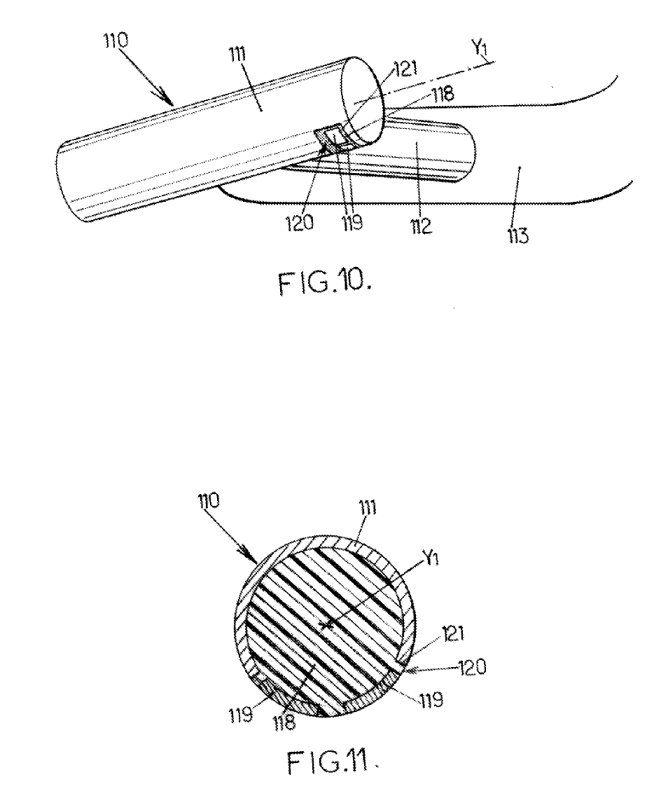

In the second embodiment of the invention, shown in FIGS. 8 to 21, the general architecture and operating principle of the automatic cycle storage system are similar to those described previously in relation to the first embodiment and will not therefore be described again in detail here.

In this second embodiment, the automatic cycle storage system may, as previously, comprise a central server S communicating with central storage station terminals 2 as described previously, each communicating by wireless link, particularly by a short range radio link of the type described above, with a plurality of cycle docking structures 107, constituted here by locking stands.

The cycles 101 in the automatic cycle storage system can in particular be bicycles comprising a frame 101a and forks 101b integral with the handlebars 101c and bearing the front wheel 101d of the cycle, as can be seen in more detail in FIG. 9.

As shown in FIGS. 9 to 11, the front forks 101c of the cycle are integral with a locking component 110, for example metal, that can be generally T-shaped. This locking component 110 can for example comprise a rigid transverse bar 111 that extends longitudinally along a horizontal axis Y1 and perpendicular to the direction of movement of the cycle in the normal position of use of the cycle. The transverse bar 111 can have a substantially circular cross-section centred on the axis Y1, and it is integral with a rigid connecting component 112, for example a metal rod that extends substantially horizontally forwards from a rigid bracket 113 integral with the front forks 101c of the cycle. The locking component 110 comprises electrical contacts 119 made from an electrically conductive material. In the example embodied here, these contacts can in particular be two in number, and they can be for example formed in the vicinity of one of the ends of the transverse bar 111.

More particularly, the electrical contacts 119 can be made on the lower part of the transverse bar 111. This transverse bar 111 can in particular be made in the form of a metal tube equipped with a cutout 121 in the vicinity of one of its axial ends and the electrical contacts 119 can be arranged in this cutout 121. The electrical contacts 119 can be borne by an insulating matrix 118 made for example from plastic, which insulating matrix can for example be moulded or fitted inside the tubular transverse bar 111.

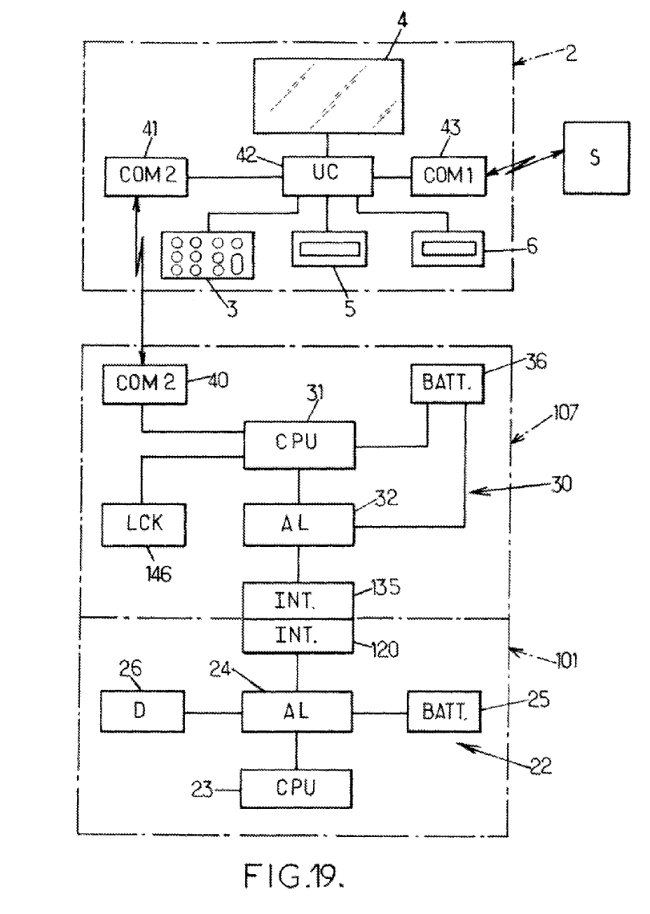

The electrical contacts 119 are connected to the electrical circuit 22 of the cycle in the same way as the electrical contacts 19 in the first embodiment described previously and this electrical circuit is similar to the one described previously, as shown in FIG. 19.

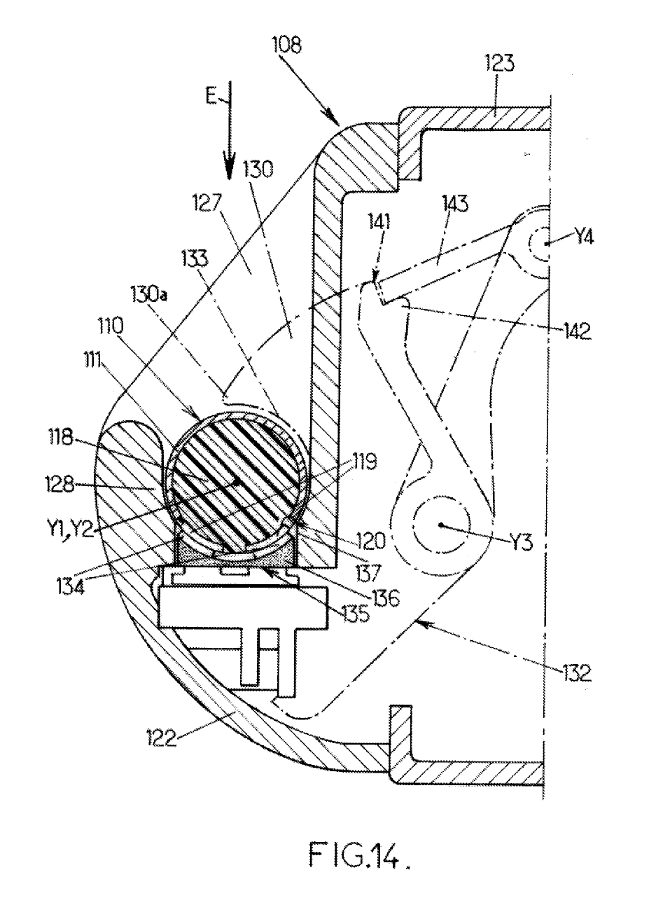

As shown in FIGS. 8 and 13, each locking stand 107 comprises a keeper 108 open upwards, which is capable of receiving the transverse bar 111 of the locking component 110 of a cycle, by engagement in a substantially vertical engagement direction E.

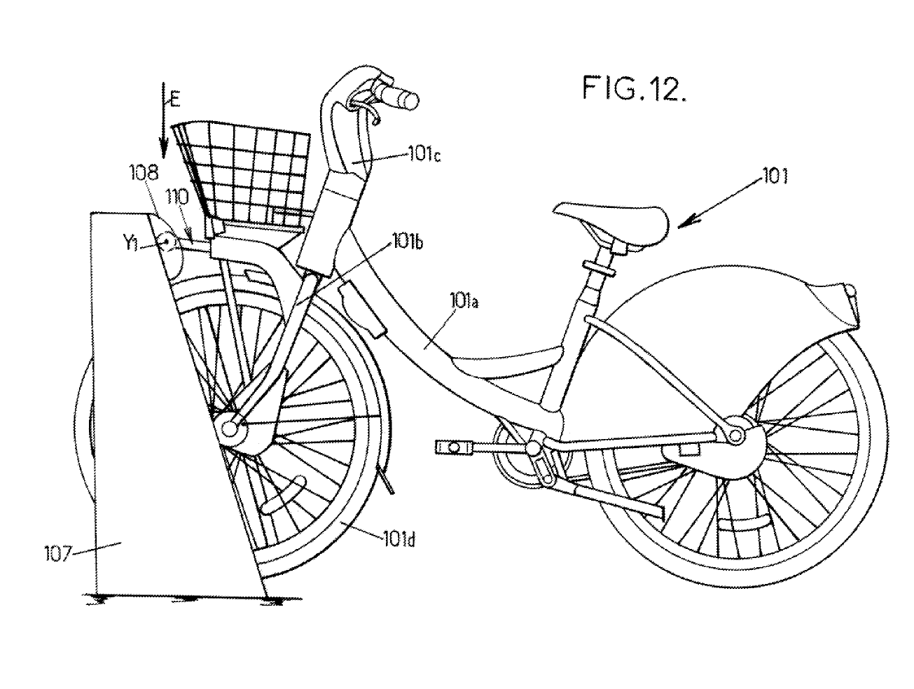

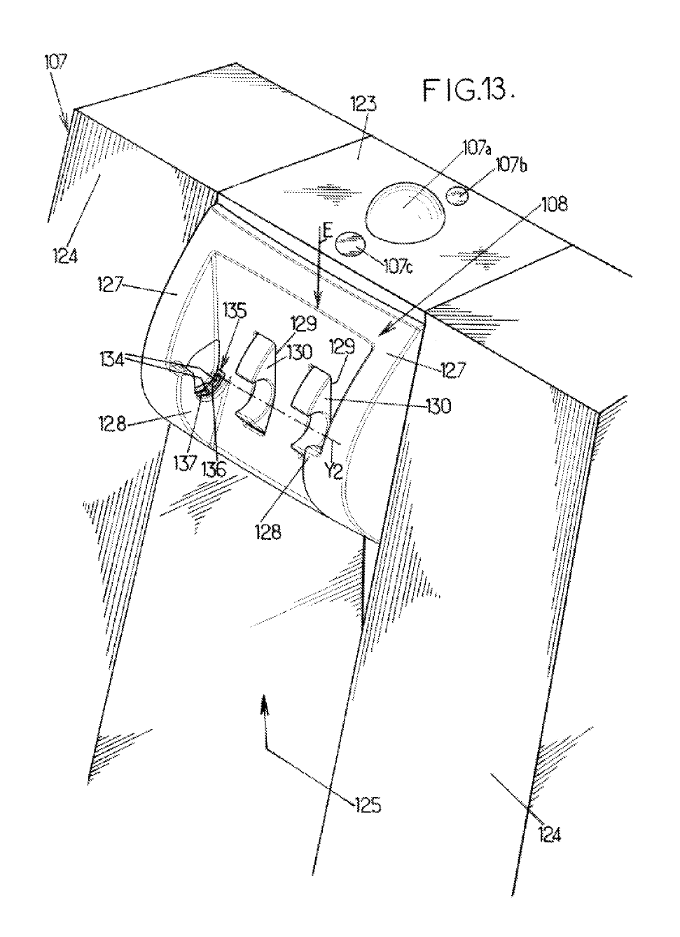

The keeper 108 can for example take the form of a rigid metal housing 122 that forms the front face of a transverse upper part 123 of the stand 107, which transverse upper part extends horizontally between two vertical lateral uprights 124 fixed to the ground. These uprights 124 define between then a vertical slot 125 extending downwards to ground level and capable of receiving the front wheel 101d of a cycle 101 locked to the locking stand 107, as can be seen in FIGS. 8 and 12. The slot 125 can for example have a width of between 7 and 12 cm.

The stand 107 can optionally comprise, like the stand 7, various accessories provided for example on its upper face, for example a contactless card reader 107a, an indicator 107b and a control button 107c that can be used for example to trigger the unlocking of a cycle 101 locked to the stand 107 once unlocking authorisation has been acquired.

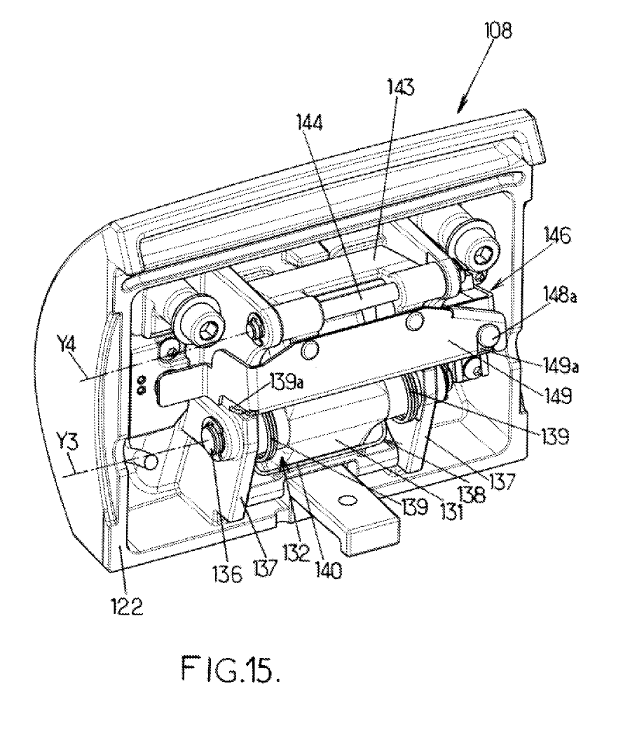

As shown in FIGS. 13 and 14, the housing 122 of the keeper 108 can for example have a substantially vertical front wall 126 which, when the locking component 110 of the cycle is engaged in the keeper 108, is parallel to the axis Y1 of the transverse bar 111. This front wall 126 is framed by two lateral walls 127 protruding towards the front of the locking stand 107, i.e. towards the cycle 101 when it is locked to said locking stand. These two lateral walls 127 extend substantially vertically and substantially perpendicular to the front wall 126, and they are separated from each other by a distance corresponding substantially to the horizontal length of the transverse bar 111, so that the keeper 108 can receive said transverse bar 111 between the two lateral walls 127, substantially without play or with little play.

Each lateral wall 127 also has, in its lower part, a receiving trough 128, open upwards, which forms, with the front wall 126, a substantially J-shaped cross-section. The two receiving troughs 128 are capable of receiving the two axial ends of the transverse bar 111 of the locking component of the cycle, by vertical engagement downwards in the direction E.

In addition, the keeper 108 comprises electrical contacts 134 made from an electrically conductive material, which are for example two in number and that together form an electric interface 135. These electrical contacts 134 can for example be embedded in a matrix of insulating material 136, for example plastic, and are connected to the electrical circuit 30 of the locking stand 107, shown in FIG. 19, which is identical or similar to the electrical circuit described previously for the first embodiment of the invention.

In the example under consideration here, the electrical interface 135 is arranged in a cutout 137 open upwards, made in the bottom of one of the receiving troughs 128, and the electrical contacts 134 are arranged so that the electrical contacts 119 on the locking component of the cycle rest respectively against the various electrical contacts 134 on the locking stand 107. Advantageously, the bottom of the receiving troughs 128 has a circular shape centred on a horizontal axis Y2 that, when the cycle is locked to the locking stand 107, coincides with the axis Y1 of the transverse bar 111. In addition, the contacts 134 are also arranged along a circular contour centred on the axis Y2, so that the electrical contacts 119, 134 do not interfere with any rotating movement of the transverse bar 111 about the axis Y1, Y2 when the cycle is locked to the locking stand 107.

Advantageously, the electrical contacts 119, 134 are shaped to be in mutual contact over a certain angular range of relative positions between the transverse bar 111 and the keeper 108 (for example a range of 10 to 20 degrees), thus allowing for the electrical connection to be maintained between the cycle 101 and the locking stand 107 even if the transverse bar 111 on the locking component of the cycle is not in a nominal angular position relative to the stand 107.

Furthermore, as can be seen in FIG. 13, the front wall 126 of the housing of the keeper 108 can for example have two vertical slots 129 through which protrude two lock plates 130 that protrude towards the front of the locking stand 107, i.e. towards the cycle 101, parallel to the two lateral walls 127.

As shown in FIGS. 15 to 18, the two lock plates 130 can be metal parts that are connected to each other at the rear of the front wall 126 by a rear transverse wall 131, so that together they form, with this rear wall, a rigid single-piece lock part 132. Each of the lock plates 130 also has, in its front part protruding from the slots 129 in the front wall 126, arc-shaped notches 133 that can each extend over approximately 180 degrees and which have a diameter that corresponds substantially to the outer diameter of the transverse bar 111 of the cycle, so that they can receive the transverse bar as will be explained below.

Each of the lock plates 130 forms, on either side of the corresponding notch 133, an upper lip and a lower lip that respectively constitute a locking component 130a and an actuating component 130b. In the locked position of the lock part 132, the notches 133 are oriented substantially horizontally forwards so that the transverse bar 111 engaged in such slots 133 is blocked in the receiving troughs 128 and prevented from coming out of such receiving troughs by the blocking components 130a of the two lock plates (see FIG. 14).

The notches 133 form with the receiving troughs 128 an arc-shaped inner contour centred on the axis Y2, which allows the transverse bar 111 to rotate freely about its axis Y1, as mentioned above. In addition, the frame 101a of the cycle 101 can pivot freely about the vertical axis of the handlebars 101c, so that the cycle cannot easily be broken or separated from the stand 107 by vandalism: the frame 101a of the cycle cannot be used by vandals as a lever arm allowing for significant force to be exerted on the locking of the cycle 101 to the stand 107.

Finally, the protection of the cycle 101 during storage is further increased by the fact that the stand 107 at least partly protects the front wheel 101d of the cycle.

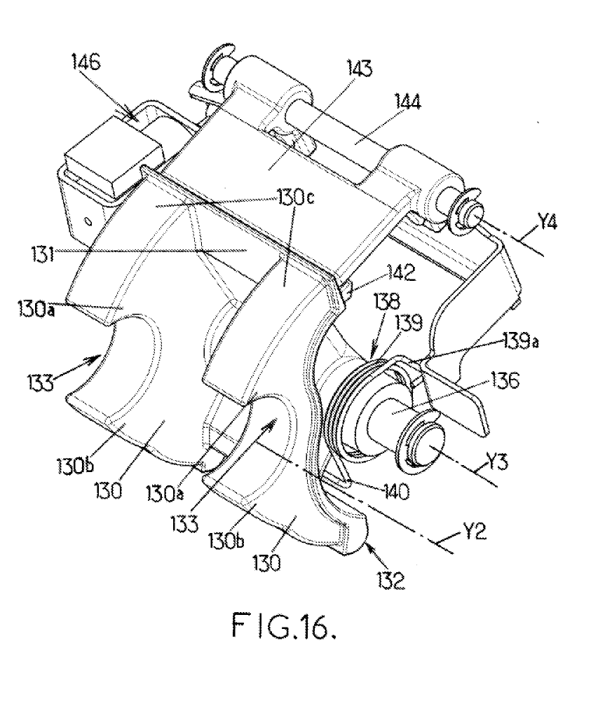

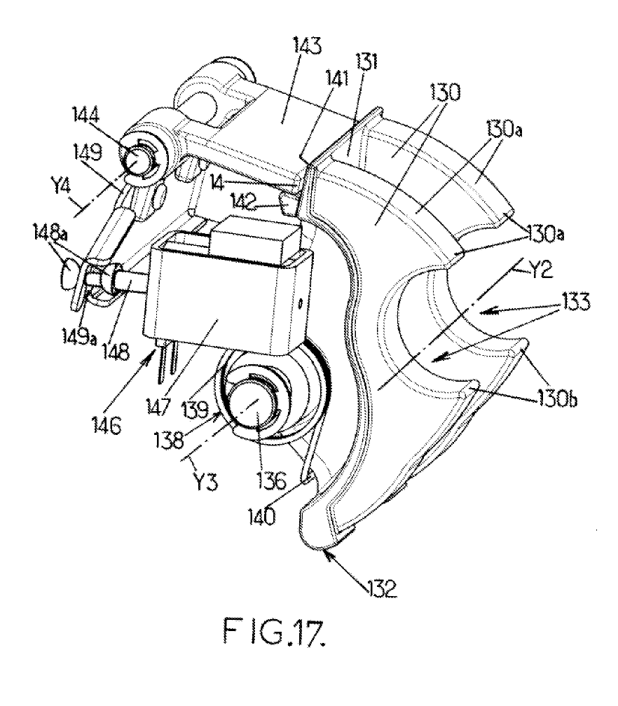

The lock part 132 is mounted pivotably around an axis of rotation Y3 parallel to the aforementioned axis Y2, for example by means of a pivot rod 136 mounted turning on two parallel vertical flanges 137 (see FIG. 15) extending perpendicularly backwards from the front wall 126 of the housing 122. In the example under consideration here, the lock part 132 is also forced upwards, towards an unlocked position that will be described below, by means of a spring 138. The spring 138 can for example be a metal wire spring comprising two windings 139 wound around the axis Y3 on either side of the rear wall of the wall 131 of the lock part, each of these windings being extended on the one hand by an end arm 139a (FIGS. 15 and 16) that rests on the corresponding flange 137 and on the other hand by a central part 140 of the flexible metal wire in the form of a stirrup, resting on the lower part of the rear wall 131.

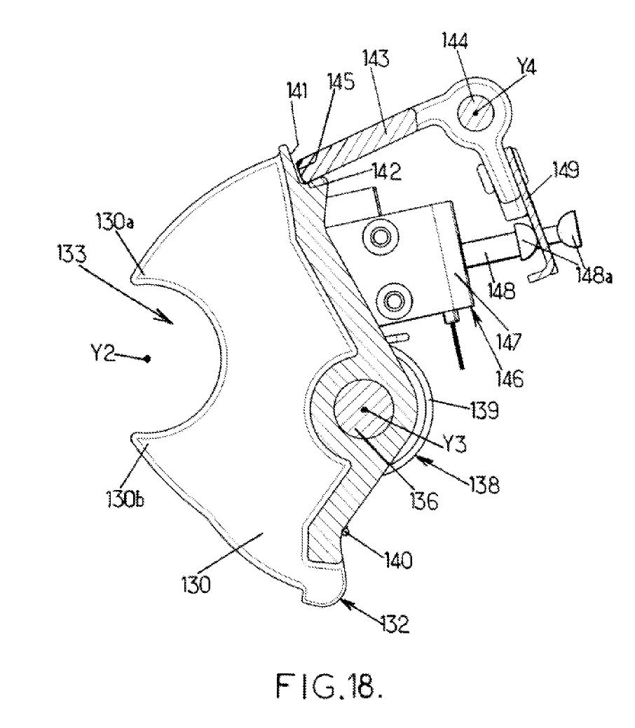

The rear wall 131 of the lock part also comprises, in its upper part, an abutment zone 141, which is oriented towards the rear and is delimited towards the bottom by a shoulder 142 oriented upwards also belonging to said rear wall 131 (see FIGS. 17 and 18).

In addition to the lock part 132, the electric lock also comprises:
a tumbler 143 in the form of a rigid metal plate mounted pivotably relative to the stand 107 around an axis Y4 parallel to the axes Y2 and Y3, for example by means of a pivot rod 144 turning in the aforementioned flanges 137, this tumbler extending substantially forwards to a front end 145 that is capable of abutting against the rear stop 141 of the lock part in such a way as to hold said lock part in the locked position described previously, despite the elastic force exerted by the spring 138,
and an electric actuator 146, for example a solenoid actuator that comprises a body 147 and an actuating rod 148 sliding longitudinally in the body 147, this actuating rod 148 being connected, for example by means of a sheet metal lever 149, to the tumbler 143. As an example, the distal end of the actuating rod 148 can be engaged in a slot 149a in the lever 149 and comprise two stops 148a arranged on either side of the sheet metal plate forming this lever 149.

The actuating rod 148 is normally elastically forced backwards, i.e. in the extended position of the rod 148, by means of an internal spring (not shown) housed in the body 146, in such a way as to force the tumbler 143 towards its abutment position in which the front end 145 of the tumbler 143 abuts against the stop 141 on the lock part. In addition, the body 147 of the actuator 146 comprises a solenoid that, when an electric current passes through it, pulls the actuator rod 148 into a withdrawn position that pivots the tumbler 143 to a retracted position in which said tumbler 143 is above the stop 141 on the lock part, which enables said lock part 132 to pivot backwards about the axis of rotation Y3 so that the notches 133 in the lock plates 130 are oriented substantially upwards, in the unlocked position.

During the transition to the unlocked position, the electrical power supply to the electric actuator 146 is brief, for example less than ten seconds and advantageously less than five seconds, as its aim is simply that the tumbler 143 no longer interferes with the stop 141 on the lock part at the start of the backwards pivoting movement of said lock part: once the pivoting has been initiated, the electrical power supply to the actuator 146 can be stopped, after which the tumbler 143 is once again pushed downwards, and said tumbler then simply rests against the circular upper surface 130a of the lock plates 130 without hindering the pivoting of the lock part 132.

The electricity consumption of the actuator 146 is therefore very low.

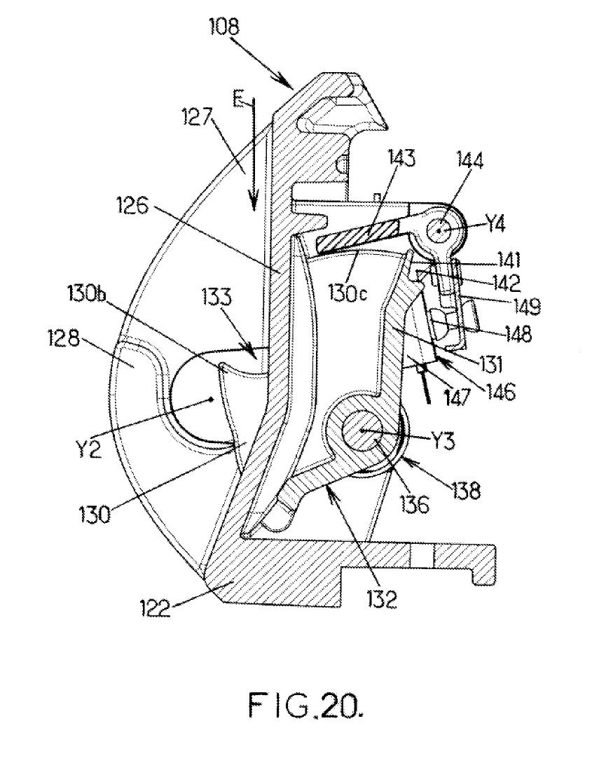

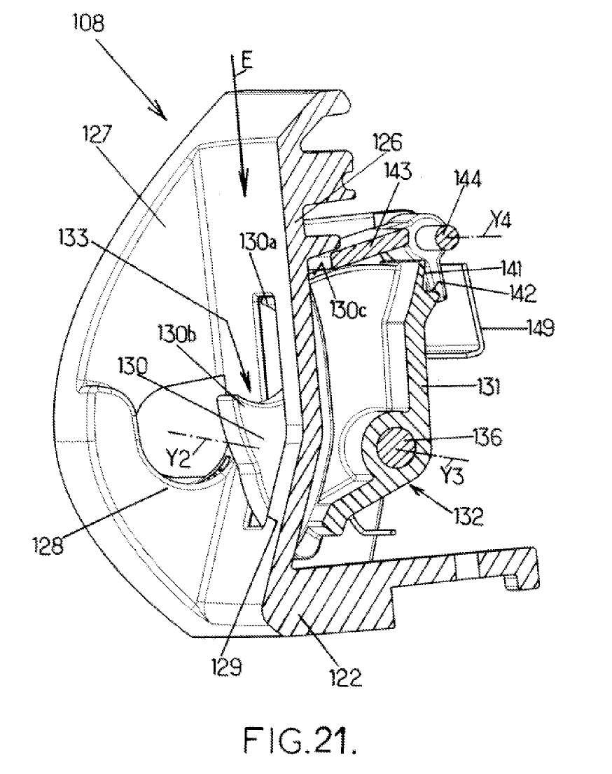

In this unlocked position, which can clearly be seen in FIGS. 20 and 21, the blocking components 130a of the lock plates 130 are retracted behind the front wall 126 and only the actuating components 130b of the lock plates are protruding forwards, so that the transverse bar 111 on a cycle can then be freely removed from the keeper 108, thus releasing the corresponding cycle 101 or, conversely, engaged in the keeper 108 vertically downwards in the engagement direction E. In this case, the transverse bar 111 on the cycle that has just been locked to the locking stand 107 pushes vertically downwards on the actuating components 130b of the lock plates, which pivots the lock part 132 downwards against the elastic force of the spring 138, until the tumbler 143 can be engaged behind the stop 141 of the lock part resting on the shoulder 142 of said lock part, after which the lock part is once again in the locked position as shown in FIGS. 13 to 18.

The method of operation of the system in FIGS. 8 to 21 is furthermore similar to that of FIGS. 1 to 7, and will not therefore be explained again here, the contacts 19, 34 in the first embodiment being replaced by the contacts 119, 134 in order to power the battery 36 of the stands 107 and allow the central units 31 on said stands 107 to communicate with the central units 23 on the cycles 101.

### Third Embodiment

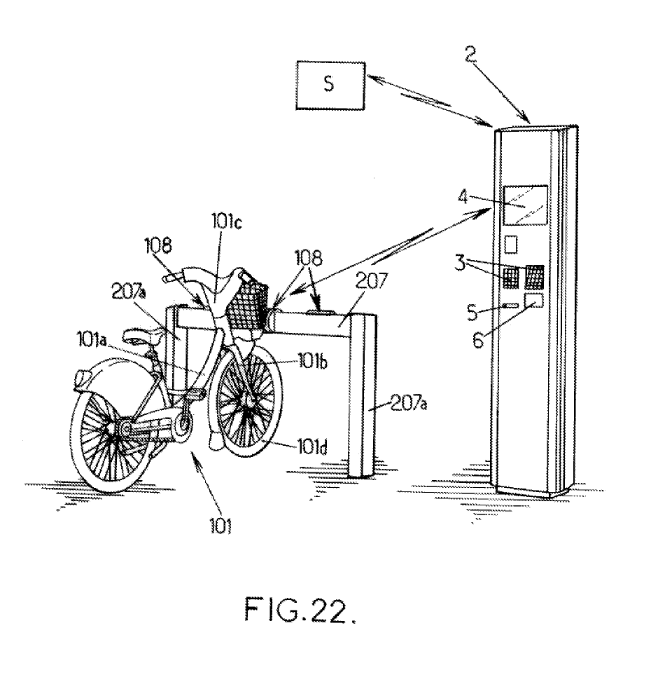

The third embodiment of the invention, shown in FIG. 22, differs from the second embodiment only in the fact that here, the docking structure 207 is a horizontal metal beam that is fixed to the ground by lateral uprights 207a, such beam including several cycle locking stations corresponding to several keepers 108 identical or similar to those already described above, fixed to one of the vertical faces or to both vertical faces of the beam 207.

In this case, each cycle storage station can comprise one or more docking structures 207.

It will be noted that in the third embodiment, the electrical circuit 30 can either be reproduced for each keeper 108, or certain elements of the electrical circuit 30 can be shared by all of the keepers 108, particularly the central processing unit 31, at least part of the electrical supply circuit 32, the battery 36 and the communications interface 40.

### Fourth Embodiment

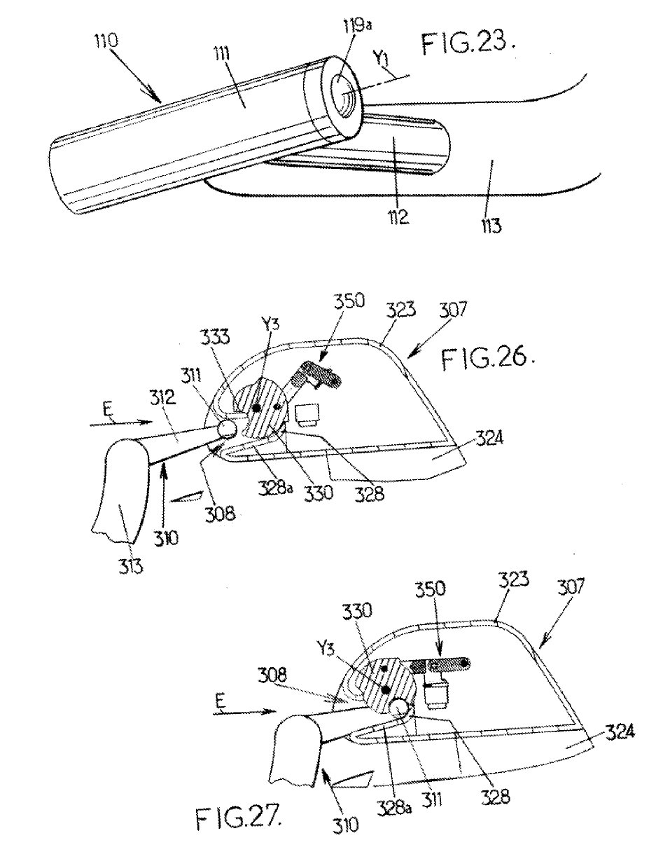

The fourth embodiment of the invention, shown in FIGS. 23 and 24, differs from the second embodiment only in the fact that:
the electrical contacts 119 are replaced by lateral electrical contacts 119a, for example in the form of two metal balls 119a that are arranged respectively at the two axial ends of the transverse bar 111 and that are elastically forced outwards along the axis Y1 so that they protrude slightly outwards,
and the electrical contacts 134 on the docking structure are replaced by two lateral contacts 134a that are formed respectively in the inner faces of the two lateral walls 127 in alignment with the axis Y2, so that the electrical contacts 119a on the cycle rest respectively on the electrical contacts 134a on the docking structure.

### Fifth Embodiment

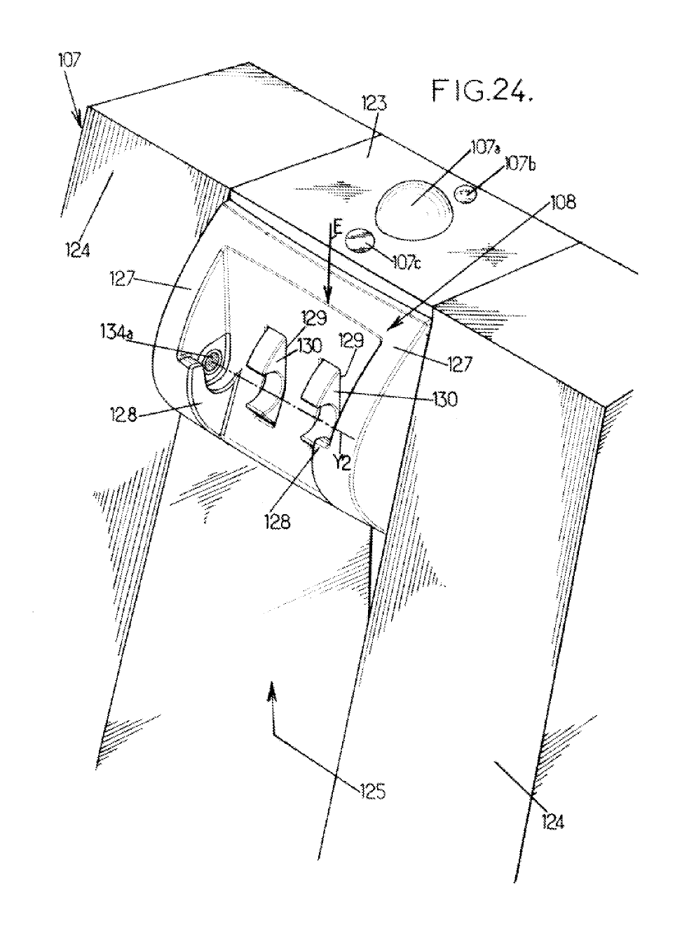

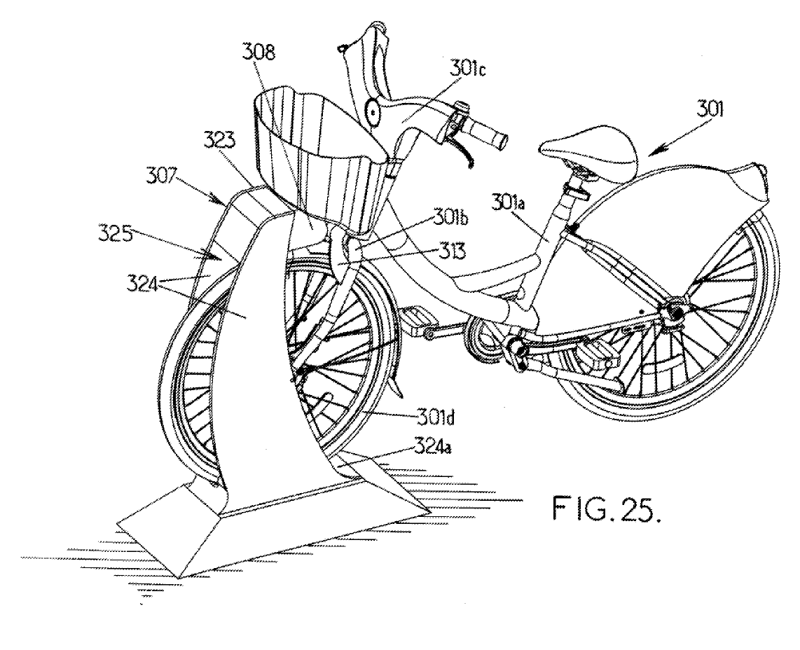

In the fifth embodiment of the invention, shown in FIG. 25, the structure and operation of the automatic cycle storage system are similar to those described previously and will not therefore be described again in detail here.

In this fifth embodiment of the invention, the cycles 301 are similar to the cycles 101 described previously, with a frame 301a that bears front forks 301b integral with the handlebars 301c and bearing the front wheel 301d, the front forks 301b being integral with rigid brackets 313 for example in the form of two lateral flanges that extend parallel to each other forwards and upwards from the two arms of the fork 301b. As shown in more detail in FIGS. 26 and 27, these lateral flanges 313 bear a generally T-shaped locking component 310, comprising a rigid transverse bar 311, similar to the rigid transverse bar 111 described previously, and a rigid connecting component 312 that extends forwards from the flanges 313. The cycles 301 can be locked to cycle docking structures 307, here constituted by locking stands, one of which is shown in FIG. 25.

This locking stand 307 has a similar general structure to the locking stand 107 described previously in the second embodiment, with a transverse upper part 123 that bears a keeper 308 capable of receiving and locking the locking component 310 of the cycle, this transverse upper part 323 extending horizontally between two vertical lateral uprights 124 integral with a base 324a, itself fixed to the ground. Provision can be made on the base 324a for the front wheel 301d of the cycle to rest on said base when the cycle is locked to the locking stand 307, which provides good control over the height of the locking component 310 of the cycle relative to the keeper 308.

As shown in FIG. 26, the keeper 308 can if applicable be open horizontally in an engagement direction E, and said keeper 308 can comprise, at each of the axial ends of the transverse bar 311, a horizontally open trough 328 the lower wall 328a of which acts as a guide for the transverse bar 311, when said transverse bar 311 is engaged horizontally in the trough 308, as shown in FIGS. 26 and 27.

The keeper 308 also comprises an electric lock that can for example comprise two lock plates 330 similar to the lock plates 130 described previously, each comprising a notch 333 capable of receiving the transverse bar 311. As shown in FIG. 27, each lock plate 330 is capable of pivoting about an axis of rotation Y3, between an unlocked position in which the notch 333 is horizontally open towards the mouth of the keeper 308 in order to receive the transverse bar 311 (FIG. 26) and a locked position in which the notch 333 is oriented downwards, substantially at 90° to the unlocked position, thus blocking the transverse bar 333 against the lower wall 328a of the trough 328. The operation of the electric lock and in particular of the lock plates 330 is therefore identical to that of the second embodiment described previously. It will be noted that, as in the second embodiment of the invention, the frame of the cycle 301 can if applicable be raised during attempted vandalism, without this attempt giving rise to any damage to the cycle 301 or the locking stand 307, as the transverse bar 311 can then pivot on itself about the axes Y1, Y2.

The aforementioned lock plates 330 are controlled by a control mechanism 350 that can be similar to the one described in the second embodiment of the invention, or preferably similar to the one described in document FR-A-2 905 927.

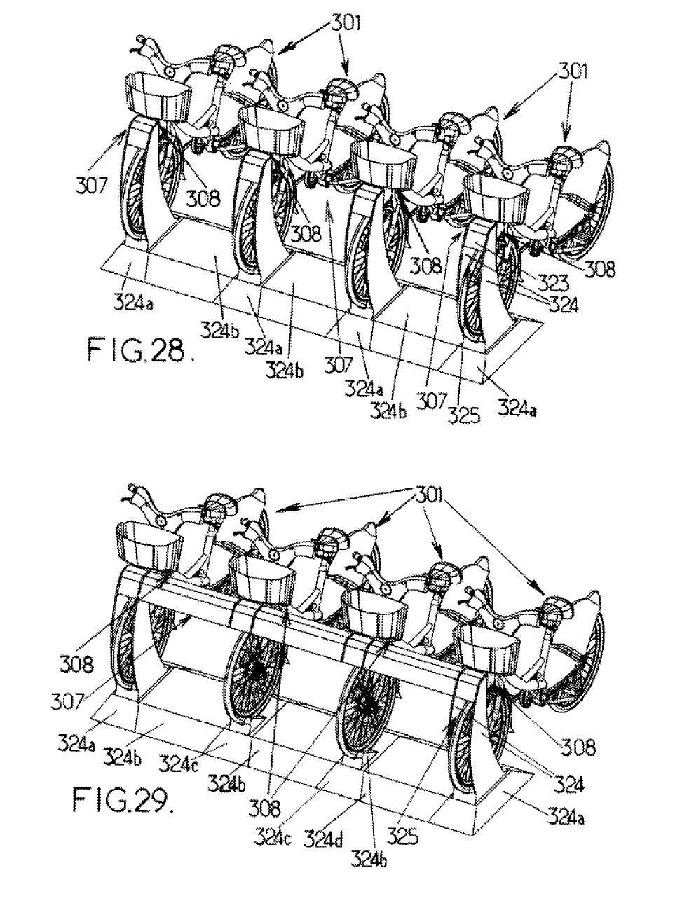

As shown in FIG. 28, several locking stands 307 of a single cycle storage station can be fixed to each other at their bases 324a, using connecting plates 324b, themselves fixed to the ground. This type of mounting can facilitate the installation of the cycle storage stations of the system according to the invention.

Optionally, as shown in FIG. 29, the cycle docking structure could comprise two locking stands 307 connected to each other by a transverse beam 307a comprising on one or both of its vertical faces, keepers 308 as previously described. In the example in FIG. 29, the docking structure also comprises additional bases 324a, each provided for example with a guide 324d for the front wheels of the cycles, in line with the keepers 308 on the horizontal beam 307a. The various bases 324a, 324c are connected to each other, as in the example in FIG. 28, by connecting plates 324b, themselves fixed to the ground.

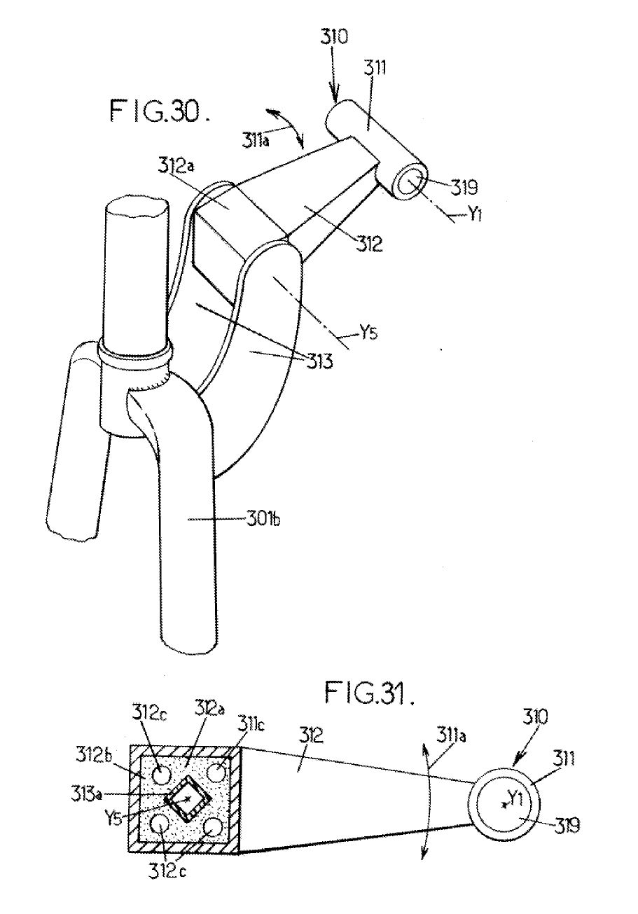

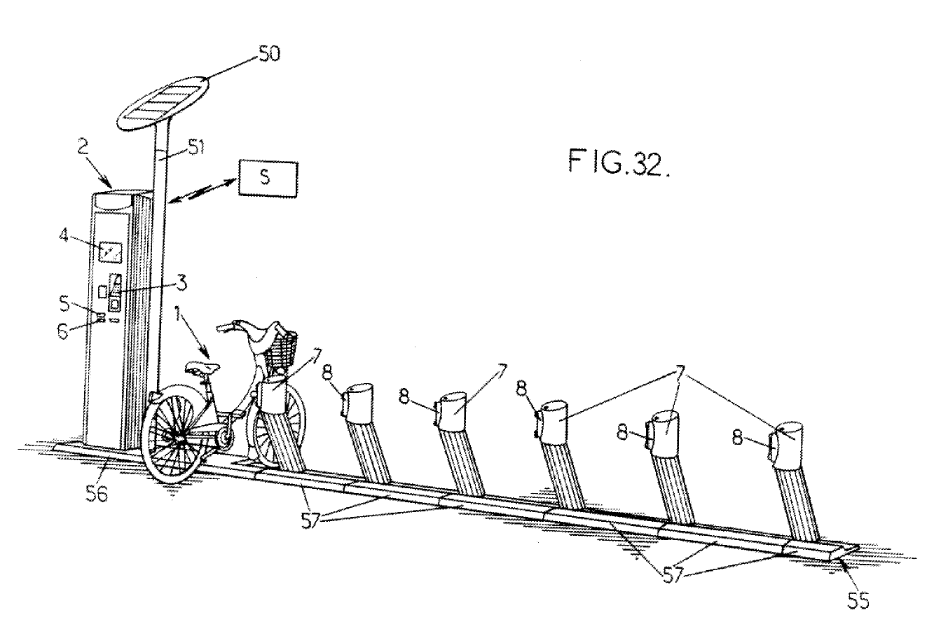

As shown in FIGS. 30 and 31, in the fifth embodiment of the invention, the locking component 310 of the cycle can if applicable be elastically connected to the lateral flanges 313, so that it can pivot about a horizontal axis Y5 parallel to the axis Y1, in the direction of the double arrow 311a.

To this end, the locking component 310 can for example be connected to the flanges 313 by means of a flexible sleeve, comprising for example:
an outer reinforcement 312a, integral with the connecting component 312 and extending about the axis Y5, such outer reinforcement having for example a tubular shape with a square cross-section,
an inner reinforcement 313a integral with the lateral flanges 313 and extending along the axis Y5, such inner reinforcement having for example a tubular shape with a square cross-section, the surfaces of which are for example angularly offset by 45° relative to the surfaces of the outer reinforcement 312a,
and an elastomer body 312b filling the intermediate space between the inner reinforcement 313a and the outer reinforcement 312a; such elastomer body can optionally comprise cavities 312c to give it more flexibility.

Finally, it will be noted that in all of the embodiments of the invention, the respective electrical circuits of the cycle and the docking structure (and in particular the batteries of such circuits) operate at the same voltage and preferably at low voltage (for example 3V or 6V) so that they have little sensitivity to the presence of water at the electrical contacts 19, 119, 119a, 34, 134, 134a.

### Sixth Embodiment

In the sixth embodiment of the invention, shown in FIGS. 32 and 33, the structure and operation of the automatic cycle storage system are again similar to those described previously and will not therefore be described again in detail.

More specifically, the cycles 1 can be identical or similar to those described in the first embodiment of the invention, as can the locking stands 7 and their keeper 8. The central station terminal 2 is also identical or similar to that in the first embodiment described previously, and it communicates as previously with a central server S, either by a radio link (GPRS) or by a cable connection (a cable connection between the central station terminal 2 and the remote server S is also possible in all of the embodiments of the invention).

In the sixth embodiment of the invention, the stands 7 and the central station terminal 2 are all held by a single pedestal 55 resting on the ground (the pedestal 55 can be fixed in place or optionally movable). In the example shown, the pedestal 55 takes the form of a relatively narrow strip that extends longitudinally in line with the central station terminal 2 and the various locking stands 7, perpendicular to the direction of attachment of the cycles 1 to the locking stands 7. The pedestal 55 can optionally be made up of a plurality of bearing plates 56, 57 abutting each other, the bearing plate 56 bearing the central station terminal 2 and each bearing plate 57 bearing one of the locking stands 7. Advantageously, the bearing plates 57 could each bear several locking stands, for example three, four or five stands.

Here, the pedestal 55 forms, with the various locking stands 7 and the central station terminal 2, the docking structure intended to receive the cycles 1 during their storage.

This docking structure can also comprise a solar panel 50, which is for example borne by a vertical mast 51 fixed to the bearing plate 56 of the central station terminal 2.

As a variant, the solar panel 50 could be borne directly by the central station terminal 2. According to another variant, the solar panel 50 could be replaced or supplemented by a wind turbine, a fuel cell or any other independent source of electric power.

As can be seen in FIG. 33, the solar panel 50 supplies electric power to a battery 52, which itself powers the various electrical appliances of the central station terminal 2, by means of an electrical supply circuit 53 that is connected at least to the central unit 42 and optionally to all or some of the electrical devices of the central station terminal 2.

The supply circuit 53 of the central station terminal 2 is also connected to the supply circuit 32 of each locking stand 7, by a cable connection running inside the pedestal 55.

The supply circuits 53, 32 are designed so that the battery 52 can supply electric power to the battery 36 of each locking stand 7 when said battery 36 reaches a first particularly low charge threshold (for example 10% of its charge). The supply circuits 53, 52 are capable of allowing the transfer of electric power only from the battery 52 to the batteries 36 of the locking stands 7, and not the reverse.

The supply circuits 53, 32 are also designed so that the charging of each battery 36 from the battery 52 of the central terminal is interrupted when the charge of the battery 36 reaches a second threshold lower than 100% of its nominal charge, this second threshold being greater than 50% for example and of the order of 70% of its nominal charge for example. Thus, the recharging of the battery 36 of each locking stand 7 takes place preferably from cycles 1, as explained previously, while the battery 52 of the central station terminal 2 preferably supplies the electrical elements of said central terminal.

Optionally, the batteries 36 of the locking stands 7 could be eliminated, in which case the battery 52 would be the only battery on the docking structure 55, 7, 2 and said battery 52 would be recharged by the cycles 1 when they are locked to the locking stands 7.

Of course, in the sixth embodiment of the invention, the locking stands 7 could be replaced by attachment beams similar to the beams 207, 307a as described previously in relation to FIGS. 22 and 29, or by any other structure allowing for the locking of the cycles 1.

As a variant, as shown in FIG. 34:
the communications interfaces 40, 41 of the locking stands or other locking structure can communicate with the communications interface 41 of the central station terminal 2 by a cable connection running inside the pedestal 55,
and/or the automatic cycle storage station can optionally also be powered by an external electricity system 54, for example the public electricity system, in order to supplement the electricity supply provided by the cycles and the solar panel 50 or any other independent means of electric power generation; this external electricity system 54 can for example be connected to the supply circuit 53 of the central station terminal 2. In this case, the supply circuit 53 can for example be designed so that the electricity system 54 recharges the battery 52 only when the charge of this battery reaches a lower threshold, for example 10% of nominal charge, this supply by the electricity system 54 being stopped as soon as the charge level of the battery 52 reaches a sufficiently high threshold, for example 70% of nominal charge, or other.

According to another variant, not shown, the automatic cycle storage station could not comprise the solar panel 50 or any other independent means of electric power generation, in which case the automatic cycle storage station would be powered on the one hand by the cycles 1 when they are locked to the docking structure and on the other hand by the external electricity system 54.

1. An automatic cycle storage system, comprising:
a plurality of cycles each comprising:
an electric power storage device,
electrical contacts,
an electrical supply circuit connecting the electric power storage device to said electrical contacts,
a plurality of fixed docking structures to which said cycles can be fixed, each comprising:
at least one central processing unit,
an electrical supply circuit connected to the central processing unit of the docking structure,
electrical contacts capable of coming into mutual contact with the respective electrical contacts on a cycle locked to the docking structure, while connecting the electrical supply circuit of the cycle to the electrical supply circuit of the docking structure,
wherein the electrical supply circuits of the cycle and the docking structure are capable of allowing the electric power storage device on the cycle to supply the electrical supply circuit on the docking structure with power when the cycle is locked to the docking structure.

2. The system according to claim 1, in which the electrical supply circuits of the cycle and the docking structure are capable of allowing only a discharging of the electric power storage device on the cycle to the electrical supply circuit of the docking structure, and not the reverse.

3. The system according to claim 1, in which the electrical supply circuit of the docking structure is not connected to any external electric power source other than the electric power storage device on the cycle, and the central processing unit on the docking structure communicates with an external control device by means of a wireless link, said external control device communicating with the central unit of the docking structure and being capable of selectively authorising the borrowing of the cycles locked to the docking structures.

4. The system according to claim 1, in which each docking structure comprises an electric power storage device connected to the electrical supply circuit of the docking structure in order to power the central processing unit of the docking structure, the electrical supply circuits of the cycle and the docking structure being capable of enabling the electric power storage device on the cycle to charge the electric power storage device on the docking structure when the cycle is locked to the docking structure.

5. The system according to claim 1, in which each cycle also comprises an electric generator capable of charging the electric power storage device on the cycle and of being driven by the moving of said cycle.

6. The system according to claim 1, in which the cycle comprises an electronic circuit connected to said electrical contacts on the cycle and said central unit of the docking structure is capable of exchanging information with the electronic circuit on the cycle by means of said electrical contacts on the cycle and the docking structure when they are in mutual contact.

7. The system according to claim 1, in which the external control device comprises at least a central server and several central station terminals each corresponding to a cycle storage station, the central station terminals communicating on the one hand with the central server and on the other hand with at least one central processing unit of a docking structure belonging to the same cycle storage station.

8. The system according to claim 1, in which each cycle comprises a locking component and each docking structure comprises at least one electric lock controlled by the central processing unit of the docking structure and capable of holding the locking component of one of the cycles thus locking said cycle to the docking structure, said electric lock being supplied with electric power by the electric power storage device on the docking structure.

9. The system according to claim 8, in which each docking structure comprises at least one locking station capable of receiving a cycle and including:
a keeper open in an engagement direction and capable of receiving the locking component of a cycle by insertion in said engagement direction,
and said electric lock, comprising a blocking component mobile between on the one hand, a locked position in which said blocking component is capable of blocking the locking component of the cycle in the keeper and on the other hand, an unlocked position in which the blocking component is capable of allowing the locking component to enter and exit the keeper;

10. The system according to claim 9, in which the cycle locking component comprises a transverse bar extending along a longitudinal axis between two ends, the keeper comprises at least one receiving trough open in said engagement direction and capable of receiving said transverse bar with its longitudinal axis arranged substantially along a fixed horizontal axis defined by the receiving trough, and the lock comprises at least one actuating component that is connected to the blocking component, said actuating component being mobile with the blocking component in a vertical plane perpendicular to said fixed horizontal axis, between:
a first position corresponding to the unlocked position of the lock, in which said actuating component is arranged to interfere with the transverse bar on the locking component when said transverse bar is engaged in the receiving trough in the engagement direction,
and a second position corresponding to the locked position of the lock, said transverse bar on the locking component being capable of moving the actuating component from its first to its second position when said transverse bar is inserted into the receiving trough, and said actuating component being capable of actuating the lock when it passes from its first to its second position moving the blocking component to the locked position.

11. The system according to claim 1, in which the docking structure comprises at least one electric power storage device and the electrical supply circuits of the cycle and the docking structure are capable of enabling the recharging of the electric power storage device on the docking structure by the electric power storage device on the cycle as long as the electric power storage device on the cycle has a charge greater than a non-zero minimum charge level.

12. The system according to claim 1, in which the docking structure is connected to at least one electric power source and comprises at least one electric power storage device, the electrical supply circuit of the docking structure being capable of enabling the recharging of the electric power storage device on the docking structure by said electric power source when the electric power storage device on the docking structure reaches a low charge threshold.

13. A docking structure for an automatic cycle storage system according to claim 1, capable of locking a cycle that comprises an electric power storage device, electrical contacts and an electrical supply circuit connecting the electric power storage device to said electrical contacts, said docking structure comprising:
at least one central processing unit capable of selectively authorising the borrowing of a cycle locked to the docking structure,
an electrical supply circuit connected to the central processing unit of the docking structure,
electrical contacts capable of coming into mutual contact with the respective electrical contacts on a cycle locked to the docking structure, connecting the electrical supply circuit of the cycle to the electrical supply circuit of the docking structure,
wherein the electrical supply circuit of the docking structure is capable of being supplied with electricity by the electric power storage device on the cycle when the cycle is locked to the docking structure.

14. A cycle for an automatic cycle storage system according to claim 1, capable of being locked to a docking structure that comprises at least one central processing unit, an electrical supply circuit connected to the central processing unit on the docking structure and electrical contacts, said cycle comprising:
an electric power storage device,
electrical contacts capable of coming into contact with the electrical contacts on the docking structure when the cycle is locked to said docking structure,
an electrical supply circuit connecting the electric power storage device on the cycle to said electrical contacts of the cycle,
the electrical supply circuit of the cycle being capable of enabling the electric power storage device on the cycle to supply power to the electrical supply circuit of the docking structure when the cycle is locked to the docking structure.

15. The cycle according to claim 14, in which the electrical supply circuit of the cycle is capable of enabling only the discharging of the electric power storage device on the cycle to the electrical supply circuit on the docking structure, and not the reverse.
